(19) United States
(12) Patent Application Publication
(10) Pub. No.: US 2005/0002372 A1
(43) Pub. Date: Jan. 6, 2005

(54) Method of and system for intra-piconet scheduling

(76) Inventors: Johan Rune, Lidingo (SE); Niklas Johansson, Sollentuna (SE); Bjorn Jonsson, Vasteras (SE)

Correspondence Address: JENKENS & GILCHRIST, PC, 1445 ROSS AVENUE, SUITE 3200, DALLAS, TX, 75202, US

(21) Appl. No.: 10/866,473

(22) Filed: Jun. 11, 2004

Related U.S. Application Data
(60) Provisional application No. 60/478,696, filed on Jun. 13, 2003.

(51) Int. Cl. H04Q 7/00; H04B 7/212

(52) U.S. Cl. 370/346; 370/444; 370/329; 370/338

(57) ABSTRACT

A method of controlling polling of slaves in a piconet includes polling the slaves in accordance with a weighted round robin (WRR) scheme and dynamically changing a weight of a participant-in-multiple-piconets (PMP) slave in order to compensate the PMP slave for absence of the PMP slave from the piconet. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims. 37 CFR 1.72(b).

### CROSS-REFERENCE TO RELATED APPLICATIONS

This patent application claims priority from, and incorporates by reference the entire disclosure of, U.S. Provisional Application No. 60/478,696, which was filed on Jun. 13, 2003 and bears Docket No. 53807-00073USPL.

### BACKGROUND OF THE INVENTION

1. Technical Field

The present invention relates generally to scheduling of nodes in an ad hoc network and, more particularly, but not by way of limitation, to scheduling of nodes that are participants in multiple piconets and scheduling of variable bit rate nodes in a BLUETOOTH network.

2. History of Related Art

BLUETOOTH is a wireless communication technology that uses a frequency hopping scheme in the unlicensed 2.4 GHz Industrial-Scientific-Medical (ISM) band. Two or more BLUETOOTH units sharing the same channel form a piconet. FIG. 1 is a diagram illustrating BLUETOOTH units in a plurality of piconets. Within a piconet, a BLUETOOTH unit can have either of two roles: master or slave. Within each piconet, there may be only one master (there must always be one) and up to seven active slaves. Any BLUETOOTH unit can become a master in a piconet.

Two or more piconets can be interconnected, forming what is called a scatternet. FIG. 2 is a diagram illustrating a plurality of piconets interconnected with one another to form scatternet. The connection point between two piconets consists of a BLUETOOTH unit that is a member of both piconets. A BLUETOOTH unit that is a member of multiple piconets is called a PMP (Participant in Multiple Piconets) node. A BLUETOOTH unit can simultaneously be a slave member of multiple piconets, but can only be master in one piconet (although a BLUETOOTH unit that acts as master in one piconet can participate in other piconets as a slave). Because a BLUETOOTH unit typically has only a single transceiver, the BLUETOOTH unit can only transmit and receive data in one piconet at a time. Therefore, participation in multiple piconets is on a time division multiplex basis.

BLUETOOTH provides for full-duplex transmission built on slotted Time Division Duplex (TDD), where each slot is 0.625 ms long. The time slots are numbered sequentially using a very large number range (cyclic with a cycle of 2²⁷). Master-to-slave transmission always starts in an even-numbered time slot while slave-to-master transmission always starts in an odd-numbered time slot. An even-numbered time slot and its subsequent odd-numbered time slot (i.e., a master-to-slave time slot and a slave-to-master time slot, except when multi-slot packets are used) are together termed a frame. There is no direct transmission between slaves in a BLUETOOTH piconet.

The communication within a piconet is organized such that the master polls each slave according to some polling scheme. With one exception, a slave is only allowed to transmit after having been polled by the master. The slave will then start to transmit in the slave-to-master time slot immediately following a packet received from the master. The master may or may not include data in the packet used to poll a slave. The exception to the above principle is that, when a slave has an established synchronous connection oriented (SCO) link, the slave is allowed to transmit in the pre-allocated slave-to-master time slot, even if the slave has not been explicitly polled by the master in the preceding master-to-slave time slot. SCO time slots are not pre-allocated on a permanent basis. Instead, when an SCO connection is established, regularly occurring time slots (in both directions), adapted to the required bit rate, are reserved for this particular connection.

The entity in the master controlling the polling of the slaves is called a link manager. The link manager also controls other link-related issues, such as selection of packet type. The only quality of service (QoS) support currently specified at the link manager level is the maximum polling interval (Tₚₒₗₗ), which defines the maximum allowed time interval between two consecutive polls of a certain slave. Tₚₒₗₗ is set on a per slave basis. In other words, different slaves may have different Tₚₒₗₗ values.

Each BLUETOOTH unit has a globally-unique 48-bit IEEE 802 address. This address, called the BLUETOOTH Device Address (BD_ADDR), is assigned when the BLUETOOTH unit is manufactured and is never changed. In addition, to the BD_ADDR the master of a piconet assigns a local Active Member Address (AM_ADDR) to each active member of the piconet. The AM_ADDR, which is only three bits long, is dynamically assigned and de-assigned and is unique only within a single piconet. The master uses the AM_ADDR when polling a slave in a piconet. However, when the slave, triggered by a packet from the master addressed with the slave's AM_ADDR, transmits a packet to the master, the slave includes the slave's own AM_ADDR (not the master's AM_ADDR) in the packet header. A master can assign AM_ADDRs 1-7 to its slaves, while an all-zero AM_ADDR is dedicated for broadcast in the piconet.

Even though all data is transmitted in packets, the packets can carry both synchronous data, on SCO links, which are mainly intended for voice traffic, and asynchronous data, on Asynchronous Connectionless (ACL) links. Depending on the type of packet that is used, an acknowledgement and retransmission scheme and forward error correction (FEC), in the form of channel coding, may be used to ensure reliable transfer of data.

In general, there are two types of scheduling in BLUETOOTH: 1) intra-piconet scheduling; and 2) inter-piconet scheduling. Intra-piconet scheduling refers to how the master of a piconet schedules the polling of slaves in the piconet. Inter-piconet scheduling refers to how a PMP node schedules its presence in different piconets and the mechanisms the PMP node uses to inform neighbor nodes to the PMP node in the involved piconets about its whereabouts and, in some cases, co-ordinate its piconet switches with the neighbor nodes.

Work is ongoing within the BLUETOOTH community to standardize an inter-piconet scheduler referred to as scatter mode. Scatter mode is briefly described below. A presence point is a well-defined point in time, where two devices (i.e., master and slave) can signal their presence in the master's piconet and their will to communicate with each other. For each link in scatter mode, both devices of the link know a presence point pattern. The presence points are distributed pseudo-randomly based on a master clock and the AM_ADDR of the slave. Presence at a presence point is not mandatory for either the master or the slave of a link. Therefore, devices must not interpret a missing response at a presence point as an indication of bad link quality.

In BLUETOOTH, a presence point consists of two slots and starts at an even slot. If a master wants to communicate with a slave in scatter mode, the master sends a presence-signaling message in the first slot of a presence point. A slave that wants to communicate with a master will listen to its master in this first slot of the presence point. If a slave receives a presence signaling packet data unit (PDU), the slave will answer with a presence signaling PDU in the subsequent (odd) slot of the presence point. After such a presence signaling PDU exchange, a communication event between the two devices starts; the communication event is defined as the period during which the devices may exchange information.

FIG. 3 is a diagram illustrating use of presence points by a master and a slave in a BLUETOOTH system. Each device is free to attend a presence point. If a master wants to use a presence point, the master transmits a signaling packet to the slave on an even slot. Otherwise, if the master does not use the slot or sends a packet of another type, the presence point is said to be unused. If a slave wants to use a presence point, the slave tries to receive a signaling packet from its master. If nothing is received, the presence point is said to be unused. If the slave responds with a signaling packet in the second (odd) slot of the presence point and the master receives the packet, the presence point is said to be successful and a communication event begins. Otherwise, the presence point is considered to have been unsuccessful.

If two devices have successfully exchanged signaling PDUs at a presence point, a communication event starts in the master-to-slave slot subsequent to the presence point. The length of a communication event is defined by the signaling at the beginning of the communication event. In a signaling packet, each device enters the number of slots the device is able to stay in the common piconet of the two devices. This number of slots is determined by a scatter-mode scheduling algorithm. The minimum of the two values determines the actual length of the communication event.

Knowing the length of communication events allows devices to schedule events after the current communication event and thus prevents devices from having to instantly decide about the next presence point to use. In other words, devices do not have to decide about the next presence point to use during the presence-point signaling procedure. Thus, pre-scheduling may be used. With pre-scheduling, a polling order is prepared in advance. The preparation in advance includes scheduling of all communication within the network, such as, for example, ACL traffic, SCO traffic, page scan (i.e., scanning for connection attempts from other units), and times when the system is idle (e.g., for power savings). The specific number of frames scheduled in advance is referred to as a batch, and the polling order defined in the batch is referred to as the batch schedule. When the batch has been prepared, the batch is fixed. The polling order in the batch cannot be changed. Pre-scheduling results in a system with reduced responsiveness. In essence, the scheduler cannot react in frame n+1 to information received in frame n. Instead, information received in frame n would affect the scheduler's behavior, at the earliest, in frame n+k, where k is a fixed number. This reduced responsiveness can be overcome, but may require hardware resources that are not appropriate (e.g., due to price and power-consumption concerns) for typical low-price, low-complexity BLUETOOTH chips.

### SUMMARY OF THE INVENTION

A method of controlling polling of slaves in a piconet includes polling the slaves in accordance with a weighted round robin (WRR) scheme and dynamically changing a weight of a participant-in-multiple-piconets (PMP) slave in order to compensate the PMP slave for absence of the PMP slave from the piconet.

An intra-piconet scheduler includes means for executing polling of at least one participant-in-multiple-piconets (PMP) slave, means for tracking presence and absence periods of the at least one PMP slave, and means for dynamically changing a weight of the at least one PMP slave to compensate the at least one PMP slave for absence from the piconet.

A method of controlling polling of slaves in a piconet includes polling the slaves in accordance with a weighted round robin (WRR) scheme and dynamically changing an effective weight of a variable-bit-rate (VBR) slave in order to maintain at least one of an agreed bit rate and a polling rate of the VBR slave.

An intra-piconet scheduler includes means for executing polling of slaves of the piconet, means for tracking a polling frequency of at least one variable-bit-rate (VBR) slave, and means for dynamically changing a weight of the at least one VBR slave to maintain at least one of an agreed mean bit rate and a polling rate.

A method of controlling polling of slaves in a piconet includes polling the slaves in accordance with a weighted round robin (WRR) scheme, dynamically changing the effective weight of a PMP slave to compensate the PMP slave for absence from the piconet, and dynamically changing the effective weight of a variable-bit-rate (VBR) slave to maintain at least one of an agreed mean bit rate and a polling rate of the VBR slave.

An intra-piconet scheduler includes means for executing polling of slaves of a piconet and means for tracking, inter-operably connected to the means for executing polling. The means for tracking includes means for tracking a polling frequency of at least one variable-bit-rate (VBR) slave and dynamically changing a weight of the at least one VBR slave to maintain at least one of an agreed mean bit rate and a polling rate of the VBR slave and means for tracking presence and absence periods of at least one PMP slave and dynamically changing a weight of the at least one PMP slave to compensate the at least one PMP slave for absence from the piconet.

A method of slave polling in a piconet includes representing slaves in an active group as elements in a ring, assigning, to each slave in the active group, of at least one element, maintaining a pointer for tracking a current polling position in the ring, and performing slave polling by sequentially progressing around the ring at least one time. At least one element of each slave is proportional to an effective weight of the slave.

A method of slave polling in a piconet includes determining whether an active group of the piconet is not empty, responsive to a determination that the active group is not empty, polling members of the active group in accordance with a weighted round robin (WRR) scheme, and, responsive to a determination that the active group is empty, polling members of a passive group of the piconet.

A method of compensating a participant-in-multiple-piconets (PMP) slave for absence from a piconet includes calculating an underservice measure relative to the PMP slave, calculating a weight multiplication factor using the underservice measure, calculating an effective weight of the PMP slave using the weight multiplication factor, and polling the PMP slave in accordance with the effective weight.

A method of compensating a variable-bit-rate (VBR) slave for lost capacity, includes maintaining a poll counter relative to the VBR slave, calculating a weight increase parameter using a value of the poll counter, adding the weight increase parameter to a basic weight of the VBR slave to yield an effective weight, and polling the VBR slave in accordance with the effective weight.

An intra-piconet scheduler includes a polling scheduler for executing polling of at least one participant-in-multiple-piconets (PMP) slave and a slave manager, inter-operably connected to the polling scheduler, for tracking presence and absence periods of the at least one PMP slave and dynamically changing a weight of the at least one PMP slave to compensate the at least one PMP slave for absence from the piconet.

An intra-piconet scheduler includes a polling scheduler for executing polling of slaves of the piconet and a slave manager, inter-operably connected to the polling scheduler, for tracking a polling frequency of at least one variable-bit-rate (VBR) slave and dynamically changing a weight of the at least one VBR slave to maintain at least one of an agreed mean bit rate and a polling rate.

An intra-piconet scheduler includes a polling scheduler for executing polling of slaves of a piconet and a slave manager, inter-operably connected to the polling scheduler, for tracking a polling frequency of at least one variable-bit-rate (VBR) slave and dynamically changing a weight of the at least one VBR slave to maintain at least one of an agreed mean bit rate and a polling rate of the VBR slave and tracking presence and absence periods of at least one PMP slave and dynamically changing a weight of the at least one PMP slave to compensate the at least one PMP slave for absence from the piconet.

### BRIEF DESCRIPTION OF THE DRAWINGS

A more complete understanding of the present invention may be obtained by reference to the following Detailed Description of Exemplary Embodiments of the Invention, when taken in conjunction with the accompanying Drawings, wherein:

FIG. 1, previously described, is a diagram illustrating BLUETOOTH units in a plurality of piconets;

FIG. 2, previously described, is a diagram illustrating a plurality of piconets interconnected with one another to form a scatternet;

FIG. 3, previously described, is a diagram illustrating use of presence points by a master and a slave in a BLUETOOTH system;

FIG. 4 is a block diagram illustrating an intra-piconet scheduler;

FIG. 5 is a graph illustrating the lead-lag concept;

FIG. 6 is a graph illustrating an ideal f(S_{U}) for an integer M_{MAX}=5;

FIG. 7 is a graph illustrating an ideal f(S_{U}) for an integer M_{MAX}=5;

FIG. 8 is a diagram illustrating single-linked active group polling rings;

FIG. 9 is a diagram illustrating double-linked active group polling rings;

FIG. 10 is a diagram illustrating insertion of elements using element distribution algorithm 3; and

FIG. 11 is a flow chart illustrating active group polling ring management.

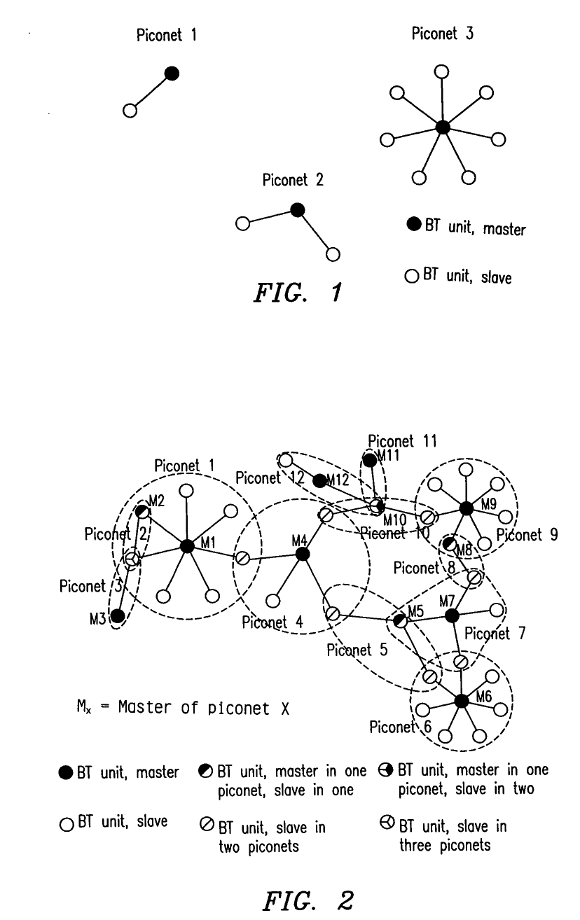

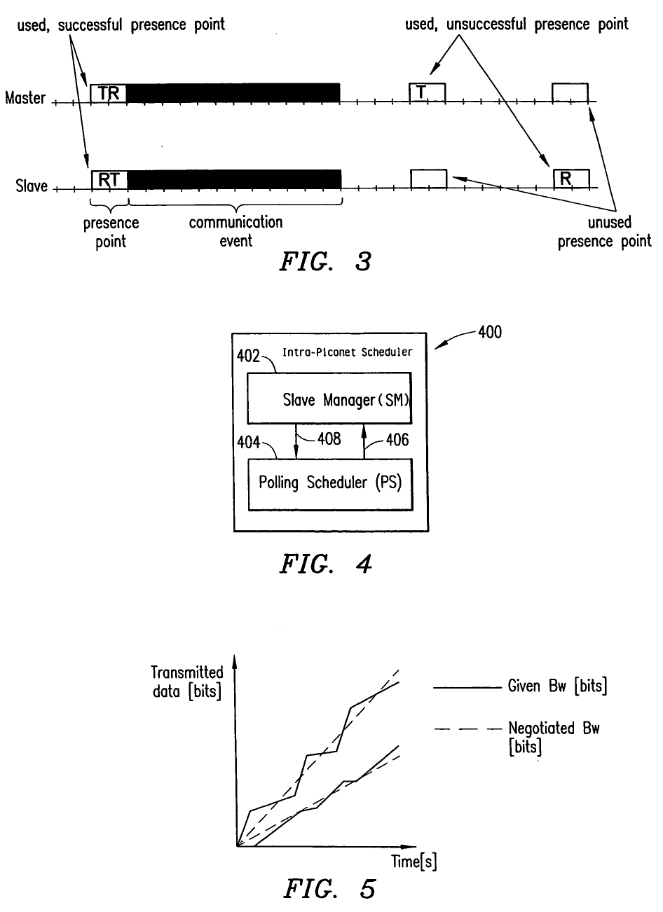

### DETAILED DESCRIPTION OF EXEMPLARY EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

As previously stated, transmission in a piconet is allowed exclusively from the master to a slave and vice versa. Furthermore, the BLUETOOTH addressing scheme states that when transmitting to the master, the AM_ADDR of the transmitting slave should be used. A consequence of this is that there is no way for a slave to send data directly to another slave in a piconet, since there is no way to address another slave and direct communication is not allowed. Hence, a slave can only communicate with the master of the piconet, while the master can communicate with all the slaves; the master may thereby act as a relay for any slave-to-slave communications.

Another feature of the BLUETOOTH system is that, in the current specification, there is no way to address and route packets from one piconet to another. Specification of how inter-piconet communication should be performed in a scatternet is one of the tasks that the BLUETOOTH Special Interest Group (BLUETOOTH SIG) is working on. Part of this work focuses on the ability of BLUETOOTH, as an ad-hoc network technology, to support Internet Protocol (IP) in a BLUETOOTH scatternet or piconet; in other words, how to run IP on top of the BLUETOOTH protocol stack.

There are currently two primary proposals for how to permit BLUETOOTH to support IP: 1) regarding each BLUETOOTH piconet as an IP subnet and running IP on top of L2CAP in each piconet; and 2) regarding an entire BLUETOOTH scatternet as an IP subnet. An adaptation layer (e.g., Network Adaptation Layer (NAL) or the BLUETOOTH Network Encapsulation Protocol (BNEP or NAL/BNEP)) is inserted between L2CAP and the IP layer. The purpose of this adaptation layer is to emulate a shared medium network (i.e., a broadcast medium) that is assumed by the IP layer.

When applicable, embodiments of the present invention will be described in the context of the NAL/BNEP approach. This should not be interpreted as a restriction of the scope of the invention. On the contrary, various embodiments of the invention may be applied along with the first proposal noted above as well as other, currently unconceived, network-enablement approaches in general, and IP networking in particular, in a BLUETOOTH scatternet.

The NAL/BNEP layer should support a number of features. First, some kind of routing mechanism to route packets within a scatternet, with emulation towards the IP layer such that the scatternet is perceived as a single shared medium network, is needed. Regardless of what routing scheme that is used to route packets through a scatternet, the routing scheme relies on the BLUETOOTH units that are members in more than one piconet to forward packets from one piconet to another. These BLUETOOTH units are henceforth referred to as forwarding nodes. A more general term is Participant in Multiple Piconets (PMP) node, which refers to a node that is connected to more than one piconet, regardless of whether or not the node forwards traffic between the piconets. Within each piconet, the master forwards the packets between different slaves. The address used to route packets within a scatternet in the NAL/BNEP approach is the BD_ADDR.

For intra-piconet scheduling, a master needs an algorithm controlling the order in which the master polls its slaves and how the master divides the available bandwidth between its slaves. Numerous scheduling algorithms have been worked out for similar problems. Examples of such algorithms are Weighted Fair Queuing (WFQ), Self-Clocked Fair Queuing (SCFQ), Worst-case Fair Weighted Fair Queuing (WF²Q), Start-Time Fair Queuing (STFQ), Class-Based Queuing (CBQ), and Hierarchical Fair Service Curve (HFSC). Each of these algorithms requires that the scheduling entity be aware of the buffer contents of all the data flows or nodes being scheduled. This is not the case when, as in a BLUETOOTH piconet, a central entity (i.e., the master node) schedules the data flows in both directions (i.e., via polling of the slaves). Furthermore, these algorithms are designed for wired networks and do not take into account the fact that wireless channels are relatively error prone.

A number of existing algorithms, such as Idealized Wireless Fair Queuing (IWFQ), Channel-condition Independent Fair Queuing (CIF-Q), Server Based Fairness Approach (SBFA) and Wireless Fair Service (WFS) use explicit signaling of buffer contents and/or channel quality prediction algorithms. However, these algorithms are not suitable as BLUETOOTH intra-piconet scheduling algorithms, as there is no signaling of buffer contents in the current BLUETOOTH specification and because the channel-quality prediction algorithms fail in BLUETOOTH due to the frequency-hopping scheme. Furthermore, from a BLUETOOTH perspective, all of the above algorithms suffer from a comparatively high level of complexity, which does not fit well into BLUETOOTH devices, for which low complexity, low power consumption, and low price are important considerations.

A number of other scheduling algorithms have been developed that are tailored for BLUETOOTH. As was the case for some of the more general algorithms above, some of these algorithms are ruled out because the algorithm relies on specification changes (e.g., new signaling), are deemed to be too complex, or because they cannot give QoS guarantees. An intra-piconet scheduling algorithm that is tailored for BLUETOOTH piconets and meets the low-complexity requirement, is Fair Exhaustive Polling (FEP). FEP uses the concept of an active and a passive group. Slaves in the active group are the slaves for which a traffic flow is currently ongoing. The slaves in the passive group are not involved in a traffic flow, but will still be polled by the master at least often enough to support the agreed maximum polling interval (Tₚₒₗₗ) for each slave. When data is transmitted to or from a slave in the passive group, the slave is moved into the active group. Similarly, when a data flow ends for a slave in the active group as detected by an empty poll packet from the master followed by an empty response packet from the slave, the slave is moved to the passive group.

Within the active group, a simple round robin polling scheme is used. A variant of FEP, which takes pre-scheduling into account, is called Batched Fair Exhaustive Polling (B-FEP). The term batched indicates that the scheduler prepares scheduling batches a certain number of frames in advance (i.e., pre-scheduling) in order to adapt to the non-ideal real-time properties of the scheduler. While B-FEP worked well in early BLUETOOTH products, and may work well in certain classes of future BLUETOOTH products, B-FEP lacks certain features that will be required in many future BLUETOOTH devices. These expected required features include:

Special treatment of PMP slaves. A PMP slave should not be polled when the PMP slave is absent from the piconet; otherwise, bandwidth is wasted. The overall performance of the system is improved if PMP nodes can be compensated for the time that they are absent from the piconet (i.e., when present in the piconet, the PMP nodes can get an increased share of the bandwidth). The B-FEP algorithm cannot do this.

Selective allocation of polling frequency to slaves. Selective allocation of polling frequency to slaves permits different slaves to be given different importance in a piconet and uneven shares of the total available bandwidth of the piconet to be allocated to different slaves (in essence giving different levels of QoS to different slaves), based, for example, on the type of device or the application running on the device. Selective allocation of polling frequency to slaves can also be used to make the allocated bandwidth equal between slaves that use different baseband packet sizes on their connections. In B-FEP, all slaves in the active group are polled equally often; therefore, there is no way of indicating that a certain slave in the active group should be polled more frequently or less frequently than the others.

Support for Variable Bit Rate (VBR) traffic. Support for VBR traffic requires more advanced mechanisms than allocating uneven shares of the available bandwidth. It requires that the intra-piconet scheduler monitor the given service levels and has mechanisms to adapt the polling frequency on a per slave basis in order to comply to agreed mean bit rates or mean polling rates (i.e., VBR agreements). All slaves in the active group are polled equally often in B-FEP. There is no way to give the slaves differentiated treatment. In particular, there are no B-FEP mechanisms that enable the intra-piconet scheduler to maintain an agreed bit rate or polling rate for a slave.

An intra-piconet scheduler as employed in various embodiments of the invention may be seen as an evolution of the FEP/B-FEP scheduler. The concepts of the active and passive groups are kept, but the scheduling principles are refined and mechanisms are introduced to: 1) compensate PMP nodes for their absence; 2) support VBR traffic; and 3) support selective allocation of polling frequency.

For purposes of illustration, it is assumed that the piconet's ACL traffic belongs to one of two traffic classes: 1) QoS traffic comparable to VBR traffic in ATM (henceforth demoted VBR traffic); and 2) best effort (BE) traffic. It is also assumed that the primary concern for VBR traffic is bandwidth and that the delay requirements are only modest (e.g., >100 ms). Furthermore, in case the delay requirements are very tight (e.g., ˜10 ms), this traffic may be scheduled as SCO traffic at the maximum rate of the VBR source. Out of these two ACL traffic classes, VBR has the highest scheduling priority (i.e., the VBR traffic is scheduled first) and the BE traffic gets what is left over.

Another assumption is that the PMP nodes only transmit best effort traffic. The rationale is that, if a PMP slave transmits VBR traffic, the VBR traffic will be handled like any VBR slave (thus leaving the responsibility to the inter-piconet scheduler to ensure that the PMP node spends enough time in each piconet so as to fulfill its QoS requirements).

FIG. 4 is a block diagram illustrating an intra-piconet scheduler. An intra-piconet scheduler 400 includes a slave manager (SM) 402 and a polling scheduler (PS) 404. The SM 402 and the PS 404 may communicate with one another, as indicated by arrows 406 and 408. The SM 402 may also be part of an entity with a wider responsibility for inter-piconet issues (i.e., going beyond the intra-piconet scheduler 400). Such an entity would not be a part of the intra-piconet scheduler 400 and may also host a piconet selection algorithm controlling how the node (provided that the node is a PMP node) switches between its different piconets

A task of the SM 402 is to keep track of the presence and absence periods of the PMP slaves and calculate the compensation that each PMP slave should receive from the PS 404. This is done by altering the polling frequency of the PMP node. The SM 402 is also responsible for ensuring that the QoS contracts are fulfilled for VBR traffic by calculating the appropriate polling frequencies.

The task of the PS 404 is to schedule the actual polling of the slaves in the piconet. This involves maintenance of the active and the passive group, calculating a suitable polling order among the slaves in the active group (and in the passive group if the active group is empty), and supervision of Tₚₒₗₗ timers. The PS 404 also maintains poll counters for VBR slaves to be used by the SM 402 when the appropriate polling frequencies are calculated. In practice, it may be easier implementation-wise to maintain poll counters for all slaves instead of only for VBR slaves.

Only very simple information is exchanged across the interface between the two entities 402 and 404. The SM 402 informs the PS 404 of when a PMP node leaves the piconet or returns to the piconet, so that the PMP node can dynamically be included in or excluded from the polling schedule of the PS 404. Furthermore, the SM 402 informs the PS 404 when the polling frequency of a PMP node or a VBR node should be changed. The PS 404 informs the SM 402 of the current values of the poll counters (upon request from the SM 402) and when a PMP node is moved in to or out of the active group. In addition, the SM 402 can retrieve certain simple pieces of information from the PS to be used in the calculation of the polling frequencies for VBR nodes.

A slave is moved from the passive group to the active group when it is detected that a data flow to or from this slave is initiated. For example, a data flow may be initiated when the slave returns user data when it is polled, due to expiration of its Tₚₒₗₗ timer, or when data for the slave arrives in the internal queue of the master. Furthermore, if information about the internal queue of a slave can be conveyed to the master somehow (e.g., at the presence point of a PMP slave), then the slave is moved to the active group if an indication of pending data in the slave is received by the master.

A slave is moved from the active group to the passive group when it is detected that the slave is no longer involved in a data flow (i.e., when the slave returns a NULL packet (or a payload packet with a zero-length payload) in response to a poll and there is no data queued for the concerned slave in the master). If there is no more data pending in the concerned slave and the internal queue in the master was empty already before the slave was polled, this leads to the characteristic POLL-NULL packet exchange. In addition, if information about the internal queue of a slave can be conveyed to the master somehow (e.g., at the presence point of a PMP slave), the slave is moved to the passive group if an indication that no data is pending in the slave is received by the master and no data for the slave is pending in the master.

To ensure that the QoS requirements are fulfilled for VBR slaves, the SM must repeatedly calculate the data rate for each VBR slave. The rate Cᵢ (measured in bits/frame) of a VBR slave sᵢ is measured over a time window of length T_{w}, measured in frames (i.e., a multiple of 1.25 ms) as follows:

$${C}_{i} = \frac{{NP}_{i} \times {S}_{i}}{{T}_{w}}$$

where NPᵢ is the number of polls during the previous T_{w} frames and Sᵢ is the maximum negotiated packet size measured in bits). Due to pre-scheduling, the intra-piconet scheduler always has to reserve the number of slots corresponding to the maximum negotiated packet size when a packet is scheduled. In another option, the number of polls during the previous T_{w} frames may be used as a measure of the rate. Yet another option, which provides higher accuracy but also increases complexity, is to measure the exact number of bits transferred during the previous time window (instead of the number of polls times the maximum negotiated packet size) when calculating Cᵢ; however, this option requires that the actually-used packet sizes be recorded. The length of the time window, T_{w}, is a design parameter that must be small enough to guarantee the delay requirements of the VBR sources.

When building its polling schedules, the PS must consider a number of different events and slaves in different states. The following are considered by the PS in various embodiments of the invention: SCO time slots, presence points that the master chooses to use, slaves in the active group, slaves in the passive group, expiration of Tₚₒₗₗ timers, and special treatment of isochronous traffic. The term presence points henceforth refers to presence points that the master chooses to use. The fact that the master chooses to use a particular presence point does not necessarily mean that the PMP slave also chooses to use the same presence point. In other words, it does not necessarily mean that the presence points are successful. Other items could be added to this list, such as, for example, slaves in the PARK, HOLD, and SNIFF modes, page procedures (i.e., connection establishments), inquiry procedures (i.e., neighbor discovery procedures), page scan periods, and inquiry scan periods.

The SCO time slots and the presence points are fixed in time; in other words, they cannot be moved by the PS. Therefore, the PS must poll an SCO slave at its reserved SCO time slots (unless an SCO time slot collides with another SCO time slot) and a PMP slave at its presence points (unless a presence point collides with an SCO time slot or a presence point of another PMP slave), provided that the master wishes to communicate with this slave.

When the active group is non-empty, the PS polls only the slaves of the active group, unless expiring Tₚₒₗₗ timers or other high-priority matters interrupt the active group polling and force the PS to poll slaves outside the active group in order to fulfill timing commitments (e.g., support for agreed Tₚₒₗₗ parameters). Other high priority matters may be SCO time slots and, if the scatter-mode inter-piconet scheduling scheme is used, presence points.

Within the active group, the PS uses a weighted round robin (WRR) scheduling. WRR is a refinement of the simple round robin (RR) scheduling algorithm. In RR, each node (or link or process or whatever item that is to be scheduled) in the group to be scheduled is scheduled one after the other, round after round. In WRR each node, link, process, etc. . . . is assigned a weight. In every round of a WRR scheduler, each node is scheduled in proportion to its weight.

For example, if a node A is assigned weight 1 and a node B is assigned weight 2, node B will be polled twice as often as node A. In particular, during the same round, node B will be polled twice while node A is polled once. Hence, by assigning different weights to different slaves, the relative polling frequency of the different slaves can be controlled. Thus, the weights can be used as a QoS mechanism to differentiate the QoS for different slaves. In addition, the weights can be used to make slaves using different baseband packet lengths effectively receive the same proportion of the bandwidth (e.g., by assigning a greater weight to a slave using short packets than a slave using long packets, the resulting higher polling frequency of the former slave will compensate it for the shorter packets). The basic weight of a slave node is assigned by entities outside the intra-piconet scheduler (e.g., by other entities in the link manager). Even though the WRR concept is well known in the art, intelligent ways to implement the algorithm in a dynamic group of nodes so that scheduling events (i.e., polls in this case) are smoothly distributed in the group are not well known in the art.

When the active group is empty, the PS polls the slaves in the passive group. This can be done according to different principles. Three examples are as follows: 1) poll the slaves in the passive group according to a simple RR scheme; 2) poll the slaves in the passive group according to a WRR scheme similar to the one used for the active group and 3) poll the slaves in the passive group only when their respective Tₚₒₗₗ timers are about to expire (the rest of the time, no slaves are polled in order to save power). When the slaves in the passive group are polled according to a WRR scheme similar to the one used for the active group, the weights for the different slaves are assigned by the PS and depend on the agreed Tₚₒₗₗ value for the respective slaves. The weights are such that, the smaller the Tₚₒₗₗ value, the greater the weight. (The reason for this is that, in the passive group, the weights are used to adapt the polling to the delay requirements of the different slaves, as reflected by the respective Tₚₒₗₗ values. In the active group, on the other hand, the weights are used to allocate different proportions of the bandwidth to the different slaves. The first of the three principles listed above (i.e., simple RR polling) is typically preferred. It is simpler than the second principle and achieves much lower delay than the third principle. In any case, when the active group is non-empty, the slaves in the passive group are polled only when their respective Tₚₒₗₗ timers are about to expire.

When the Tₚₒₗₗ timer expires for a slave, this slave will be polled, irrespective of whether the slave is currently included in the active group or not. If two Tₚₒₗₗ timers expire almost simultaneously (so that they interfere with each other), then one of the nodes will be polled earlier than stipulated by its Tₚₒₗₗ timer, so that neither of the nodes will experience a polling interval that is longer than its agreed maximum polling interval. Such adjustments are necessary when two Tₚₒₗₗ timers expire at the same time slot or when the time between the expiration of two Tₚₒₗₗ timers is not enough to allow the first of the two slaves to be polled before the Tₚₒₗₗ timer of the other slave expires. This problem and the resulting scheduling adjustments can be generalized to three or four or even up to seven interfering Tₚₒₗₗ timer expirations. The PS, of course, considers the Tₚₒₗₗ timers in order of expiry time (earliest first). The number of Tₚₒₗₗ timers that will be considered by a Tₚₒₗₗ interference adjustment mechanism is a design choice that boils down to a trade-off between scheduling accuracy and complexity.

To be able to completely guarantee that the Tₚₒₗₗ parameters of all the slaves are supported, the PS considers all the current Tₚₒₗₗ timers; however, this may lead to unacceptable amounts of computation. Hence, a compromise may be preferable, such as, for example, considering the two earliest expiring Tₚₒₗₗ values. The result of this would be that, in certain infrequent situations, a slave node would be polled after the expiration of its Tₚₒₗₗ timer; on the other hand, the complexity and computational volume of the PS would be limited. The simplest approach is to consider only the earliest expiring Tₚₒₗₗ timer.

The PS also has to set aside its regular polling schedule (i.e., active or passive group polling) in order to handle SCO time slots and, if used, presence points. Thus, the polling of a slave whose Tₚₒₗₗ timer is about to expire may be moved earlier in time in order to avoid interference from simultaneous or overlapping SCO time slots and presence points (that the master would like to use). The principles are the same as when considering interfering Tₚₒₗₗ timer expirations. Thus, SCO time slots and presence points can be integrated in scheduling adjustment calculations when checking for interfering Tₚₒₗₗ expirations.

The main task of the SM is to keep track of the presence and absence periods of the PMP slaves and to calculate the polling frequency compensations that each PMP slave and VBR slave should receive from the PS. Operation of the SM may be divided into two distinct parts: 1) the compensation that each PMP slave should receive; and 2) the adaptive polling frequency to support the QoS requirements for VBR sources.

The presence and absence periods are relevant only while a PMP slave belongs to the active group. If a PMP slave that belongs to the passive group is absent, it is not being deprived of its opportunities to send or receive buffered data. In other words, the absent PMP slave is not being underserved. Likewise, a present PMP slave cannot be compensated for earlier underservice (i.e., the PMP node lagging its agreed rate) while belonging to the passive group.

The SM maintains an underservice measure (S_{U},) for each PMP slave in the piconet. The SM makes the PS compensate an underserved PMP slave via a weight multiplication factor (M), which is calculated as a function of S_{U} (i.e., M=f(S_{U})). The SM assigns M for each slave and the PS calculates a slave's effective weight (W_{E}) by multiplying the slave's basic weight (W_{B}) by the slave's M (i.e., W_{E}=M×W_{B}). The basic weight for a best effort slave (or any other slave) is never less than a certain minimum value that must be greater than 0. If integer values are used, the minimum value is 1. Requiring the basic weight to be greater than zero ensures that a best effort slave in the active group always gets a share of the available capacity irrespective of the presence of PMP slaves and slaves with QoS requirements. In other words, starvation of best effort slaves is avoided. Although the default value for the basic weight should be the minimum value, it could sometimes be useful to set the basic weight to other values (e.g., to differentiate between the best effort slaves). The effective weight (W_{E}) of a slave is what the PS uses in its WRR algorithm in the active group polling. M can assume values (preferably only integer values) between 1 and Mₘₐₓ. The default value (and initial value) of M is typically 1.

The first task of the SM is to maintain an S_{U} parameter for each PMP slave in the piconet. A PMP slave that is not underserved has an S_{U}=0. This is always the case for a PMP slave in the passive group. For an underserved PMP slave, S_{U} can have any value between 0 and S_{Umax}, with S_{Umax} representing the highest level of underservice.

The SM maintains the S_{U} parameter for a PMP slave by integrating the time that the PMP slave (while belonging to the active group) is absent from the piconet and present in the piconet. The absence time is integrated with a positive sign and the presence periods (during which a PMP slave is compensated for earlier absence) are integrated with a negative sign. A PMP slave is being underserved when it is absent while belonging to the active group, since it is then not receiving the share of the bandwidth that it would have received had it been present in the piconet.

A PMP slave is being compensated when it has a weight multiplication factor greater than 1 (i.e., M>1) while belonging to the active group. If M=1, the PMP slave is not being compensated, since it is then just receiving the part of the bandwidth that it is entitled to according to its basic weight (W_{B}). Only the part of the received bandwidth that is due to the fraction of M that is above 1 (i.e. M−1) should be regarded as the compensation given to the PMP slave. Therefore, the integrated presence periods (while in the active group) should be multiplied by −(M−1)=1−M, while the integrated absence periods (while being in the active group) should be multiplied by 1. And as soon as a PMP slave is moved out of the active group, the S_{U} of the PMP slave should be set to 0 and its M should be set to 1. The actual integration can be, for example, a simple multiplication by the number of frames of the concerned presence or absence period.

Thus, conceptually, the value of S_{U} changes continuously (although in practice S_{U} may be discretely calculated) while the PMP slave is in the active group (although S_{U} remains unchanged while the PMP slave's M=1). As stated above, M is calculated as a function of S_{U}. f(S_{U}) should make M=1 when S_{U}=0 and M=Mₘₐₓ when S_{U}=S_{Umax}. For the range of S_{U} values between 0 and S_{Umax}, the resulting distribution of M values is a design choice. M may be recalculated more or less continuously. But M could also be recalculated less frequently (e.g., every time a PMP slave returns to the piconet from an absence and, if M for a returning PMP slave was calculated to a value greater than 1, when the PMP slave has been compensated for the previous underservice).

In another option, more compensation could be given to PMP slaves that are forwarding nodes (i.e. PMP slaves that forward traffic between piconets) than to PMP slaves that are non-forwarding nodes. One way to do this would be to introduce a constant forwarding node multiplication factor, (M_{F},), which would be used in the calculation of an effective weight multiplication factor (M_{E}) for forwarding nodes. The M_{E} parameter would be used instead of the regular M parameter when calculating the effective weight (i.e., W_{E}=M_{E}×W_{B}). However, when calculating the S_{U} parameter, the regular weight multiplication factor (M) would still be used. With pseudo-code, the calculation of M_{E} could be expressed as follows:

M=f(S_{U});

IF “PMP slave is a forwarding node” AND M>1 THEN M_{E}=MIN(M_{F}×M, Mₘₐₓ)

ELSE M_{E}=M;

Another, almost equally simple, way could be expressed as follows:

M=f(S_{U});

IF “PMP slave is a forwarding node” THEN M_{E}=f(MIN(M_{F}×S_{U}, S_{Umax})

ELSE M_{E}=M;

Another possibility could be to use the M_{F} parameter to always give a forwarding node a larger proportion of the bandwidth than indicated by its basic weight (W_{B}), unless its forwarding node status is already reflected in W_{B}. This would mean that the M_{F} parameter should be used also when M=1. This could be expressed as follows:

M=f(S_{U});

IF “PMP slave is a forwarding node” THEN M_{E}=MIN(M_{F}×M, Mₘₐₓ)

ELSE M_{E}=M;

The SM informs the PS of changes in the weight multiplication factors of the PMP slaves when necessary. The PS informs the SM whenever a PMP slave is moved into or out of the active group. Another task of the SM is to inform the PS of when a PMP slave leaves the piconet or returns to the piconet. For this task, the inter-piconet scheduling mechanisms provide input data to the SM. If scatter mode is used, the result of the signaling at the presence points is used as input data.

Since the WRR scheduling algorithm only gives a relative traffic rate and the weights of the different slave's change continuously, some scheme able to adapt the weights according to the current traffic conditions is needed to be able to give bandwidth guarantees for VBR traffic. As is the case for the best effort slaves in FEP, VBR slaves are moved between the active and the passive groups as outlined above. This means that at some interval in time (while in the passive group), the VBR slave will not get any bandwidth capacity, which must be made up for at some later point in time in order to fulfill the QoS requirements (i.e., the VBR slave needs to be compensated for the lost capacity). Hence, as opposed to the compensation for lost capacity for PMP nodes, the VBR slaves will be compensated for the time that they spend in the passive group. The incentive for moving VBR traffic to the passive group is to minimize the number of void polls (i.e., the case where both the master and slave queues are empty for the connection in question) and thereby increase the overall throughput in the network. At other intervals in time, a VBR slave might have been given too much capacity due to mismatches in the weight calculations. These mismatches occur when the weights are only updated every Tᵤₚ (update period) frames.

In order to account for the variations in the capacity given to a VBR slave and, to the extent possible, to maintain the agreed capacity, a lead-lag model is employed. The lead-lag concept is used in many wireless scheduling algorithms. Leading means that a flow has received more capacity than requested over a period of time at the expense of other flows. Lagging flows are flows that over a period of time have received less capacity than negotiated. The compensation model determines how leading flows give up their lead and how lagging flows make up for their lag. FIG. 5 is a graph illustrating the lead-lag concept. In FIG. 5, an example with two flows with different negotiated bandwidth (the dotted lines) as well as their lead and lag (the zigzag lines) is shown. When the bandwidth after a period of time is below the dotted line, the flow is lagging. When the opposite holds, the flow is leading. However, in the long run, flows should follow the dotted lines. When leading, the alternatives are to continue to lead (keep the same gradient), decrease the gradient, or stop transmitting (horizontal line) until lagging. The opposite holds for a lagging flow.

All traffic associated with a QoS slave is analyzed, and the number of successful transmissions over a period of time is recorded. Three different approaches to how this information should be used are suggested, depending on the interpretation of the concept of bandwidth guarantees. Under one approach, the slaves are guaranteed a raw bandwidth (i.e., regardless of whether a slave answered (to a poll) with a null or data packet or did not respond at all, it will be regarded as the slave has received an opportunity to transmit a packet with the maximum packet size). Another approach takes the null answers and lost packets into account and calculates the amount of successfully transmitted data (i.e., a null packet is not considered as a successfully transmitted data packet since it does not contain any data). A third approach that is a further refinement of the second approach, takes into account how much data the packets sent to and from a slave contained.

Which approach to use depends on what the scheduler is supposed to guarantee. However, the approach and calculations are the same; the only difference is what is stored in the memory. Henceforth, for discussion purposes it is assumed that the first approach is used. Furthermore, it is assumed that there is at most one flow per slave; thus, the words flow and slave may be used interchangeably. However, the intra-piconet scheduling mechanism allows multiple flows per slave as long as the master can distinguish between them.

To build the lead-lag model, the PS maintains a poll counter (NPᵢ) for each VBR slave (sᵢ) in the piconet. This poll counter reflects the number of polls within the last time window (T_{w}) and may be used to calculate the given rate for the last window. The time window is continuously sliding, such that at any given time tₓ, the time window represents the time between tₓ−T_{w} and tₓ. In order to simplify the implementation, it is also possible to use a non-sliding time window (i.e., a time window that is restarted after each expiration). The disadvantage of such discrete time windows is that they allow compensation calculations only at certain points in time (i.e., at the expiration of a time window). (Although discrete time windows allow calculation of the lead-lag compensation at any time, only at the expiration of a time window can the calculation be based on fresh input data.)

The SM requests the value of a poll counter from the PS whenever the SM needs the poll counter value in the lead-lag compensation calculations. It would also be possible to let the PS calculate the rate of a VBR slave Cᵢ and transfer Cᵢ instead of the poll counter upon request from the SM. However, it is henceforth assumed that the PS transfers the raw poll counter value to the SM. The SM makes the PS compensate an under/overserved VBR slave via a weight increase parameter, K, which is calculated as a function of NPᵢ (i.e., K=f(NPᵢ)). As opposed to the weight multiplication factor used by the PMP nodes, this parameter is added to the basic weight and not multiplied by the basic weight. The SM assigns K for each VBR slave and, for the VBR slaves in the active group, the PS calculates each slave's effective weight (W_{E}) by adding the slave's K to the basic weight (W_{B}) (i.e., W_{E}=W_{B}+K). The resulting effective weight (W_{E}) of a slave is what the PS uses in its WRR algorithm in the active group polling. The incentive for measuring the given rate over a finite time span is to limit the effect of possible mismatches in the past, which otherwise could affect the given rate indefinitely.

Considering that a non-PMP slave has M=1 and that a non-VBR slave has K=0 and that a slave cannot simultaneously be a PMP slave and a VBR slave, it is possible to formulate the following generic expression for W_{E}:
W_{E}=M×W_{B}+K.
As previously described, slaves are moved from the active group to the passive group during times when the slave does not have anything to transmit and vice versa. As before, a VBR slave in the passive group has an effective weight W_{E} equal to zero and is only polled when the Tₚₒₗₗ timer expires or when the active group is empty. Normally (for best effort traffic), when a slave in the passive group is moved to the active group, the slave is given a capacity that corresponds to its basic weight; however, for VBR slaves, the basic weight is increased by K (calculated as above) to reflect the possible over/under service (lead or lag) that the slave has received in respect to the QoS requirements (i.e., W_{E}=W_{B}+K).

In order to reduce the complexity as much as possible, the effective weight may be updated continuously. Instead, the effective weight may be updated every Tᵤₚ frames, where Tᵤₚ≦T_{w} (or perhaps Tᵤₚ<<T_{w}). The length of this period is a trade-off between computational efficiency and responsiveness. The SM informs the PS of changes in the weight increase parameters of the VBR slaves when necessary. The PS informs the SM of the values of the poll counters, when requested by the SM (i.e., as governed by the update timer(s)).

An exemplary realization of an intra-piconet scheduler will now be described. Low complexity solutions requiring small computational resources are aimed for in the example. Thus, computationally-intensive floating point operations are avoided. Hence, all mathematical operations in the example are integer operations, including integer divisions. Integer divisions are indicated by double division signs (//). Integer division is an operation using a truncation principle. In other words, integer division is achieved by truncating the result of regular division (between two integers) to the nearest smaller integer value. To achieve better accuracy, the integer division operation can be complemented such that the end result is equal to the result of regular division rounded to the nearest (smaller or greater) integer value. The following is one way to realize such a rounding principle: Integer division is an operation using a truncation principle. In other words, integer division is achieved by truncating the result of regular division (between two integers) to the nearest smaller integer value. To achieve better accuracy, the integer division operation can be complemented such that the end result is equal to the result of regular division rounded to the nearest (smaller or greater) integer value. The following is one way to realize such a rounding principle:
quotient=numerator/denominator
≈(2×numerator+denominator)//(2×denominator)

Furthermore, all involved parameters in the realization example are integers, including, for example, the W_{B} and M parameters. Various properties of the example are as follows:
(1) Only one expiring Tₚₒₗₗ timer is considered at a time.
(2) An optional look-ahead function can be used to check whether the poll due to (one) future expiring Tₚₒₗₗ timer is blocked by SCO slot(s) or presence point(s) and consequently has to be handled earlier.

(3) Plain RR polling is used for passive group polling (i.e., when the active group is empty).
(4) When a new slave is connected to the piconet, it is by default placed in the passive group.
(5) Scheduling of inquiry, page, inquiry scan, and page scan periods are not included.
(6) Handling of slaves in the power-save modes SNIFF, HOLD, and PARK is not included.

In the example discussed below, a number of indexed parameters are used. These indices are: index “i” indicates a slave in the piconet, index “old” indicates the previous value of the concerned parameter, and index “new” indicates the new value of the concerned parameter. Furthermore, index “a” stands for “absence”, index “p” stands for “presence”, index “c” stands for “current”, index “comp” stands for “compensation”, and index “event” stands for event.

The SM is responsible for management of PMP slaves and VBR slaves. First, the compensation that each PMP slave should receive is described and thereafter the adaptive polling frequency to support the QoS requirements for VBR sources is presented.

The possibility to give PMP slaves that are forwarding nodes extra compensation is not used. When the SM assigns a weight multiplication factor M to a PMP slave in order to compensate the PMP slave for previous underservice, the SM lets the assigned value of M remain constant (as long as the PMP slave remains in the active group) for a certain fixed compensation time (T_{comp}). The function f(S_{U}) and the constant T_{comp} are chosen such that the assigned value of M roughly results in a full compensation of the underserved PMP slave if the PMP slave remains in the active group for a time period equal to T_{comp}. Thus, T_{comp}=S_{Umax}//(Mₘₐₓ−1). The unit for S_{U} as well as T_{comp} is frames. Since M can take only integer values, the value of M will increase stepwise as S_{U} increases.

Different principles can be used as lodestars when designing the function f(S_{U}). Two quite natural principles are: 1) the compensation received by an underserved PMP slave during a time period equal to T_{comp} should be as close as possible to the actual compensation the PMP slave is entitled to; and 2) the compensation received by an underserved PMP slave during a time period equal to T_{comp} should be as close as possible to, but never exceed, the actual compensation the PMP slave is entitled to.

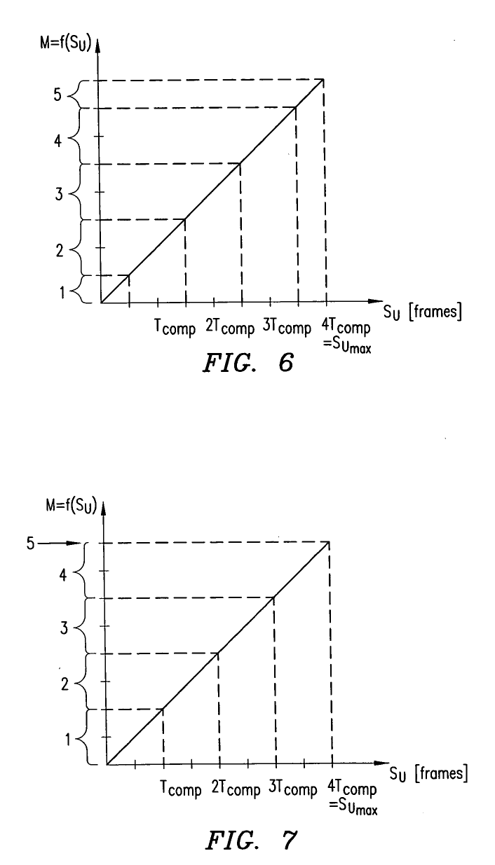

FIG. 6 is a graph illustrating an ideal f(S_{U}) for an integer Mₘₐₓ=5 following the first of these two principles. In FIG. 6, a continuous M parameter is rounded to integer values in a way minimizing the round error. The resulting function can be expressed as follows:
M=f₁(S_{U})=(S_{U}+S_{Umax}//(2×(Mₘₐₓ−1)))//(S_{Umax}//(Mₘₐₓ−1))+1={T_{comp}=S_{Umax}//(Mₘₐₓ−1)}=(S_{U}+T_{comp}//2)//T_{comp}+1
Since T_{comp} is a configurable constant, T_{comp}//2 is also a configurable constant, which means that this integer division never has to be performed in real-time, which may be significant from a computational efficiency point of view.
Proposed values for S_{Umax}, T_{comp}, and Mₘₐₓ are:
S_{Umax}=256 frames
T_{comp}=64 frames
Mₘₐₓ=5

Following the second of the two above-described design principles for the function f(S_{U}), the ideal f(S_{U}) for M is illustrated in FIG. 7 (with Mₘₐₓ assumed to be 5). In FIG. 7, a continuous M parameter is truncated to integer values, such that M approximates, but never exceeds, the ideal continuous M parameter. The resulting function can be expressed as follows:
M=f₂(S_{U})=S_{U}//(S_{Umax}//(Mₘₐₓ−1))+1=S_{U}//T_{comp}+1
The proposed values for S_{Umax}, T_{comp}, Mₘₐₓ can be the same as proposed in conjunction with the f(S_{U}) proposed for the first design principle. In other words:
S_{Umax}=256 frames
T_{comp}=64 frames
Mₘₐₓ=5

To support the calculation of S_{U} for each slave, the SM should, for each slave, record the times for the events that are relevant for the S_{U} calculations. These events are: 1) a PMP slave enters the active group; 2) a PMP slave leaves the active group (although the time for this event does not have to be recorded); 3) a PMP slave in the active group leaves the piconet; 4) a PMP slave in the active group returns to the piconet; 5) a PMP node has received full compensation for previous underservice (this event is optional depending on which of the two below described alternatives is used); and 6) events other than the above triggering an update of the underservice measure S_{U} (applicable only if such other optional triggering events, e.g., timer-triggered S_{U} updates, are used).

The underservice parameter S_{U} should be updated at each of these events, except when a PMP slave enters the active group (because then the S_{U} parameter of the PMP slave will always be 0). The weight multiplication factor should be recalculated whenever S_{U} is changed. The SM should update the PS with the new weight multiplication factor whenever the weight multiplication factor is changed and the PS needs to be informed of the change. First of all, this includes the event that a PMP slave in the active group returns to the piconet. Theoretically, it would also include the event that a PMP slave with M>1 leaves the active group (causing its M to be set to 1). However, in another option, the PS can be designed to set M=1 for a PMP slave that leaves the active group. In addition, theoretically, it would also include the event that a previously underserved PMP slave has been fully compensated (i.e., that the PMP slave has remained in the active group with M>1 for a time period equal to T_{comp}, causing M to be set to 1). However, by configuring the PS with the fixed T_{comp} parameter, the PS itself can keep track of when a PMP slave is fully compensated and set the PMP slave's M to 1, which would relieve the SM from the burden of keeping timers supervising the compensation periods of the PMP nodes. A reason for letting the SM inform the PS in these two situations (i.e., not designing the PS to be able to update the weight multiplication factor itself) is that it would make the two entities more independent of each other, thereby facilitating independent evolution of the PS and SM. An advantage of not requiring the SM to inform the PS in these two situations is that the amount of the information transferred across the SM-PS interface is reduced.

The SM manages a VBR slave by repeatedly altering the weight increase parameter (K) of the VBR slave in order to make the resulting service that the VBR slave receives from the PS conform to any applicable QoS agreements. In this example, the QoS agreement consists of an agreed mean bit rate. Assuming that the VBR slave always uses the largest packet size that is allowed for the connection, the agreed bit rate translates into a polling rate; this is what the SM aims to control.

At the expiration of the update timer (Tᵤₚ), which may concern all VBR slaves or only one, the SM should calculate and assign a new weight increase parameter (K) to each of the concerned VBR slaves and inform the PS of the new K value. The choice whether to let the Tᵤₚ timer concern all VBR slaves (i.e., a common Tᵤₚ timer) or only one (i.e., a separate Tᵤₚ timer for each VBR slave) is not trivial. A common Tᵤₚ timer implies that all VBR slaves are updated sequentially at approximately the same point in time. The K calculations would then interfere with each other, such that the first VBR slave to be updated would get the most inaccurate K value and the last VBR slave to be updated would get the most accurate updated K value.

One approach to address this issue is to iterate the K calculations until the calculation errors are reasonably small for all VBR slaves. However, an iterative scheme increases the complexity and computational requirements of the algorithm and makes the calculation time unpredictable. Another approach is to update the weights in random order. Even though this would lead to unfairness at small time scales, it would be fair at longer time scales. Another approach is to update the different VBR slaves at different points in time (i.e., distributing the K calculations for different VBR slaves in time). If the K calculations for the different VBR slaves are evenly distributed in time, this approach would be fair at long time scales. The drawback is that it requires a separate Tᵤₚ timer for each VBR slave.

The realization example for the WRR algorithm used by the PS presented herein has low complexity and low computational requirements as its lodestars. The M, K, W_{B}, and W_{E} parameters are integers. M can take any integer value in the range [1, Mₘₐₓ] and K can take any integer value in the range [Kₘᵢₙ, Kₘₐₓ]. W_{B} can take any integer value in the range [1, W_{Bmax}] and W_{E} can take any integer value in the range [1, W_{Emax}]. Typical parameter values may be Mₘₐₓ=5 , W_{Bmax}=5, Kₘᵢₙ=0 or 1−W_{B}, Kₘₐₓ=24 or 25−W_{B}, and W_{Emax}=25.

The WRR realization example is based on the concept of an active group polling ring. The basic concept of the active group polling ring is to represent the active group as a circular list or ring of slaves to be polled. While polling the active group, the PS polls one slave in the ring after the other, going through the ring sequentially round after round. However, if the ring were to contain only one element for each slave in the active group, the resulting polling would be plain RR polling of the slaves in the active group. In order to reflect the different weights of the slaves, each slave is represented in the ring by a number of elements that is proportional to its effective weight, W_{E}. Since W_{E} is an integer that can take values in the range [1, W_{Emax}], each slave can simply be represented in the ring by a number of elements equal to the slave's W_{E} parameter. Hence, if a slave's W_{E}=1, the slave has one element in the ring, if the slave's W_{E}=4, the slave has four elements in the ring, if the slave's W_{E}=20, the slave has 20 elements in the ring, if the slave's W_{E}=W_{Emax}, the slave has W_{Emax} elements in the ring, etc. . . .

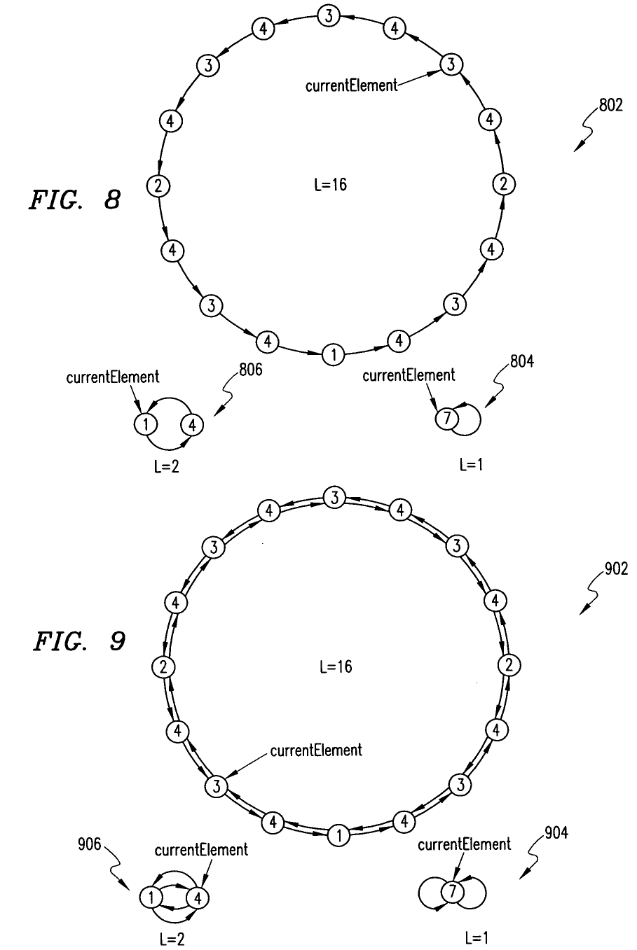

To keep track of the current position in the ring, the PS maintains a currentElement pointer. The currentElement pointer is stepped one step in the ring before or after each poll of a slave corresponding to an element in the ring. The PS also maintains a parameter (L) containing the length in number of elements of the ring. An empty ring is indicated by L=0 and currentElement→void. Depending on the chosen implementation, an explicit empty-ring indication (e.g., a Boolean parameter called ringEmpty) can also be useful in some situations. The active group polling ring concept is illustrated in FIG. 8 (single-linked rings) and FIG. 9 (double-linked rings). The choice between a single-linked ring and a double-linked ring is implementation-dependent.

FIG. 8 is a diagram illustrating single-linked active group polling rings. In a ring 802, a slave 1 has a single element, a slave 2 has two elements, a slave 3 has five elements, and a slave 4 has eight elements. A ring 804 includes only a single element, with L=1. A ring 806 includes 2 elements, one element of slave 1 and one element of slave 4. In the ring 806, L=2.

FIG. 9 is a diagram illustrating double-linked active group polling rings. In a ring 902, a slave 1 has a single element, a slave 2 has two elements, a slave 3 has five elements, and a slave 4 has eight elements. A ring 904 includes a single element for slave 7. A ring 906 includes two elements, one for each of slave 1 and slave 4; therefore, L=2.

Using the active group polling ring, as the PS completes a round in the ring, each slave in the active group will have been polled a number of times that is proportional to its effective weight (W_{E}). Thus, WRR is achieved. Assuming that the elements of the ring do not change, the scheme will achieve fairness during an interval equal to the time it takes for the PS to complete one round in the ring. If interruptions in the active group polling (e.g., due to SCO time slots, presence points, etc. . . . ) are disregarded, this interval can never be greater than Nₘₐₓ×W_{Emax}×Pₘₐₓ frames, where Nₘₐₓ=7 is the maximum number of slaves in the piconet and Pₘₐₓ=5 is the maximum number of frames that can be allocated for a single poll. Furthermore, if a slave leaves the active group, and its elements in the ring consequently are removed, the remaining slaves in the active group will share the polling resources given up by the slave that left the active group. The share that each of the remaining slaves in the active group will receive will be proportional to its effective weight (W_{E}). Thus, the scheme achieves max-min fairness.

The above-described properties are valid irrespective of how the elements of the different slaves are distributed in the ring. However, if the elements of a slave are evenly distributed along the ring, the active group polling is smoother with low (or at least slowly changing) delay variation.

The PS manages the active group polling ring by inserting elements into the ring and removing elements from the ring as the slaves in the active group change, as slaves leave and return to the piconet, as the effective weights (W_{E}) of the slaves in the active group change, as slaves are disconnected from the piconet, and, possibly, when new slaves are connected to the piconet. The actions performed by the PS, triggered by these different events, are described further below.

When a slave that is present in the piconet is included in the active group, W_{E} elements should be inserted in the ring for this slave, preferably distributed as evenly as possible. (It is possible to insert elements in the ring also for an absent slave that is included in the active group. This depends on how absent slaves are treated.) This can of course be achieved in many different ways, but only ways that also satisfy the low-complexity and computation-efficiency requirements are of interest.

A simple way to distribute the elements is to go through the ring sequentially (starting in the position indicated by the currentElement pointer) and insert the W_{E} new elements with L//W_{E} of the old elements in between every two consecutive new elements (where L is the length of the ring before the insertion of the new elements). This is very simple and straightforward and will in most cases achieve a reasonably even distribution of the elements. However, it does not perform well under all circumstances. If, for instance, 20 new elements are to be inserted in a ring of 19 elements, the number of old elements in between two new elements will be calculated to 19//20=0. This means that all the 20 new elements will be inserted in a sequence after each other followed by the 19 old elements. The new elements could not be more unevenly distributed. Still, such occasional mishaps may be tolerable in view of the attractive simplicity of this distribution algorithm. The algorithm performs better, at the cost of an increase in complexity and computation intensity, if the previously-described rounding principle is applied to the L//W_{E} calculation, thereby turning it into (2×L+W_{E})//(2×W_{E}). This algorithm (irrespective of whether plain integer division is used or integer division with the rounding principle) is termed element distribution algorithm 1.

A way to avoid the severe lumping of elements (which, in its most severe form, occurs only when W_{E}>L in the plain integer division variant and when W_{E}>2×L in the variant with integer division with the rounding principle) in element distribution algorithm 1 is to “reverse” the calculations when W_{E}>L. That is, if W_{E}>L, then W_{E}//L is calculated instead of L//W_{E}. The result indicates the number of new elements that should be inserted after each old element (i.e. in between every two old consecutive elements). When element distribution algorithm 1 is complemented with this scheme, the resulting algorithm is termed element distribution algorithm 2.

An even simpler way to overcome the above-described “lumping” problem is to use L//W_{E}+1 old elements in between two new elements instead of L//W_{E}. If, after going through a complete lap in the ring, there are still new elements to insert, the PS just continues in the same way (using the same number of intermediate old elements) starting on a second lap. During this second lap, the new elements that were inserted during the first lap are considered to be old elements. This distribution algorithm performs acceptably in all cases, but there is still room for improvements. This algorithm is termed element distribution algorithm 3.

Yet another way to improve the element distribution algorithms is to attempt to better approximate the ideal non-integer number of intermediate old elements by alternating between L//W_{E} and L//W_{E}+1 intermediate old elements in a controlled fashion. To be able to do this, a more accurate value of the number of intermediate old elements than is obtained from the integer division L//W_{E} has to be produced. This is achieved by extracting the first decimal, denoted D, from the fictive non-integer division L/W_{E} by calculating D as D=(10×L)//W_{E}−10×(L//W_{E}) truncated to an integer value. The result of this operation is that D has an integer value representing the first decimal of the fictive non-integer division L/W_{E} (i.e., D=10×“the first decimal”). That is, if L/W_{E}=3.4, D=4, if L/W_{E}=4.672, D=6, if L/W_{E}=0.95, D=9, etc.

As a next step, a parameter, denoted DefSur, indicating the deficit or surplus of accumulated intermediate old elements, is introduced. DefSur is initialized to D. Every time an element is inserted with L//W_{E} intermediate elements, DefSur=DefSur+D (after the insertion). Every time an element is inserted with L//W_{E}+1 intermediate elements, DefSur=DefSur−(10−D)=DefSur+D−10 (after the insertion). If, before the insertion of a new element, DefSur<10, then use L//W_{E} intermediate elements when inserting that new element. If, before the insertion of a new element, DefSur≧10, then use L//W_{E}+1 intermediate elements when inserting that new element. This algorithm achieves the best distribution of the inserted elements of the presented element distribution algorithms, but it is also the most complex and computationally intensive. This algorithm is termed element distribution algorithm 4. All aspects considered, the best of the above-described algorithms is probably element distribution algorithm 3.

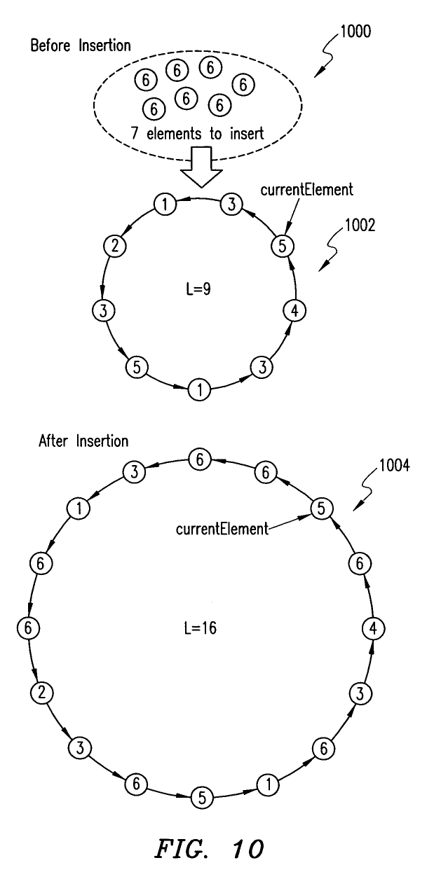

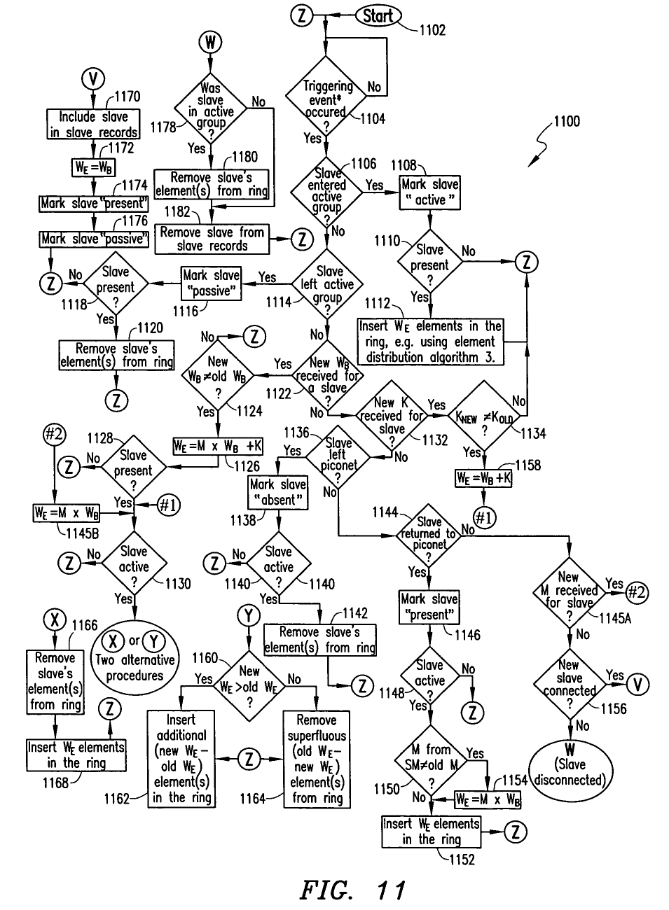

FIG. 10 is a diagram illustrating insertion of elements using element distribution algorithm 3. In FIG. 10, seven elements 1000 of a slave 6 need to be inserted into a ring 1002. Following insertion of the elements 1000, the ring 1002 appears as indicated in FIG. 10 by a ring 1004. When the number of elements to be inserted in the ring is great, an unacceptably high peak load may result, depending on the available hardware resources. A way to address this situation is to distribute the insertions in time. Instead of inserting all elements at once, the PS inserts the elements one at a time in their respective appropriate positions as the PS works its way around the ring during the active group polling (further described below). If batching is used, the PS can insert the new elements per batch before each consecutive batch is prepared. To ensure that the PS inserts the elements in the right positions in the ring, two counters are maintained for each slave in the active group. One counter, the remainingElementsToInsert counter, keeps track of the number of new elements that remain to be inserted for the concerned slave. The other counter, the remainingElementsUntilNextInsertion counter, keeps track of the number of intermediate old elements in the ring that are still to be passed before the next new element is inserted. When the insertion of elements starts for a slave entering the active group, the remainingElementsToInsert counter is initialized to W_{E} and the remainingElementsUntilNextInsertion counter is initialized to a number ranging from 0 to the largest number of intermediate old nodes to be used between two inserted new elements (during this particular insertion). A suggested initialization number for the remainingElementsUntilNextInsertion counter in this range is, for example, 0, which makes the PS insert the first new element immediately.

Every time the PS moves one step in its active group polling (i.e., every time an old element in the ring triggers the polling of the slave the element represents), the remainingElementsUntilNextInsertion counter is decreased by one. When the remainingElementsUntilNextInsertion counter reaches zero, the next new element is inserted in the ring, the remainingElementsToInsert counter is decreased by one, and the remainingElementsUntilNextInsertion counter is reset to the number of intermediate old nodes to be used before the next insertion. When the remainingElementsToInsert counter reaches zero, the distributed insertion of all the new elements (associated with that particular slave) is completed. The PS must keep track of all the distributed insertions that are ongoing for the slaves in the active group. The PS can do this by checking the slaves in the active group (looking for remainingElementsToInsert counters that are greater than zero) before or after each step in the active group polling.

A better way for the PS to keep track of ongoing distributed insertions may be to maintain a list of slaves, termed insertingSlaveList, for which distributed insertions are ongoing. This way, the PS does not have to check all the slaves in the active group at each step of the active group polling and, when the insertingSlaveList is empty, the PS does not have to check any slaves at all. This insertion distribution scheme may be used together with any of the above-described four element distribution algorithms.

When a slave is moved out of the active group, the slave's elements in the ring should be removed. This can be done all at once or, to reduce the peak load, distributed in time. If the latter approach is used, the PS removes the elements of the concerned slave whenever one is found as the PS steps through the ring during the active group polling. Hence, when using the distributed removal strategy, the PS must always check whether the current element in the ring represents a slave that actually belongs to the active group. If not, the element is removed from the ring. As before, a list, termed removingSlaveList, may be used to keep track of which slaves to remove.

When the W_{E} parameter of a slave in the active group is changed, due to a changed M or K parameter from the SM or a new W_{B} parameter is assigned from other entities in the link manager, the slave's number of elements in the ring should be changed accordingly. If an even distribution of the elements is to be maintained, the easiest way to handle this situation is to simply remove all the slave's existing elements from the ring and then insert the new number of elements, using the regular element distribution algorithm.

This removal and insertion method is very simple, but it is not very computationally efficient. Smaller load can be achieved if the existing elements are not removed as the first step when W_{E} for a slave in the active group is changed. Instead, if W_{E} is increased (W_{Enew}>W_{Eold}), the existing elements are left as they are and only the additional elements (equal to W_{Enew}−W_{Eold}) are inserted. The additional elements are inserted using the regular element distribution algorithm. When doing this, the slave's existing elements in the ring are treated just like any other elements. When W_{E} is decreased (W_{Enew}<W_{Eold}), the superfluous elements (equal to W_{Eold}−W_{Enew}) are removed.

The elements to be removed should be selected such that the remaining elements are still reasonably well distributed in the ring. This selection can use the same basic principles as the element distribution algorithms described in conjunction with insertion of elements in the ring. That is, the PS can remove every W_{Eold}//(W_{Eold}−W_{Enew}) or every W_{Eold}//(W_{Eold}−W_{Enew})+1 of the concerned slave's elements or alternate between the two using a control parameter similar to DefSur. When using these algorithms, the other elements in the ring (i.e., those representing other slaves) are disregarded and could be considered as transparent to the element removal selection algorithms. After several such insertions and removals, the elements in the ring will most likely be non-evenly distributed. A way to alleviate this would be to remove all elements in the ring and then reinsert them at certain points in time.

When a PMP slave leaves the piconet, it should no longer be polled. However, the PMP slave may still belong to the active group. If it belonged to the active group when the PMP slave left the piconet, it will remain in the active group when it returns to the piconet, unless the master receives indications that no data is pending for the concerned PMP slave (in either direction, to or from the PMP slave). A simple way to handle this situation is to simply remove the existing elements of the PMP slave from the ring. If the PMP slave still belongs to the active group when the PMP slave returns to the piconet, the slave's elements are reinserted in the ring. It should be noted that it is quite likely that the W_{E} parameter of the PMP slave is increased when the PMP slave returns so as to compensate the PMP slave for lost capacity.

A way to reduce the load associated with the removal and reinsertion of the PMP slave's elements is to let the PMP slave's elements remain in the ring, even when the PMP slave is absent from the piconet (as long as the PMP slave belongs to the active group). An absent indication must then be set for the PMP slave, either in a list of active group slaves (or a list of all slaves) or in each of the elements of the PMP slave. Elements of an absent PMP slave (i.e., elements with absent indications in themselves or belonging to a PMP slave for which an absent indication is set) should be disregarded by the PS during the active group polling. When the PS comes across an element of an absent PMP slave during the active group polling, the PS should simply iterate to the next element in the ring. When elements are inserted in the ring, the elements of an absent PMP slave may or may not be disregarded. This choice will not significantly impact the result of the insertion using the element distribution algorithms. But the choice should be reflected in the ring length parameter L. If the elements of absent PMP slaves are disregarded during insertions, these elements should not be included in the L parameter. In other words, L should reflect the number of elements belonging to present slaves. If the elements of absent PMP slaves are not disregarded during insertions, these elements should be reflected in the L parameter. Then L=0 cannot be used as an implicit empty-ring indication. This is when the explicit empty-ring indication (i.e., the ringEmpty parameter) becomes useful.

When marking a PMP slave in the active group as absent, the PS must check whether the active group thereby becomes empty, which would trigger the PS to switch to passive group polling. When a previously-absent PMP slave with elements remaining in the active group polling ring returns to the piconet, its W_{E} may or may not be the same as when the PMP slave left the piconet. If the W_{E} parameter has changed, the absent indication is removed and the insertion or removal of elements is handled as described for the case when W_{E} is changed for a slave in the active group. If the W_{E} parameter has not changed, only the absent indication has to be removed, since the already existing ring elements of the PMP slave appropriately reflect the unchanged W_{E} parameter. This algorithm requires that elements for an absent PMP slave be inserted in the ring when an absent PMP slave is moved into the active group.

The actions by the PS when a PMP slave belonging to the active group returns to the piconet depends on which of the two above-described ring management strategies is used when a PMP slave leaves the piconet. If all the elements of a PMP slave are always removed from the ring when the PMP slave leaves the piconet, the PS simply inserts the number of elements indicated by W_{E}, when the PMP slave returns to the piconet, unless the PMP slave has been moved out of the active group during its absence. The elements are inserted using the same element distribution algorithm as when a slave enters the active group.

If the elements are left in the ring when a PMP slave in the active group leaves the piconet, there will always be existing elements in the ring for a returning PMP slave (in the active group), provided that elements are inserted in the ring when an absent PMP slave is moved into the active group. In this case, the PS will handle a returning PMP slave belonging to the active group such that the absent indication for the PMP slave is removed and, if the W_{E} parameter has changed, the consequent insertion or removal of elements is handled as described for the case when W_{E} is changed for a slave in the active group.

When a new slave is connected to the piconet, the intra-piconet scheduler is informed of this by another entity (e.g., an entity in the link manager). At the same time, the basic weight (W_{B}) of the new slave is received. The new slave is incorporated into the slave records of the PS and marked as present.

Two exemplary ways to handle the default status of the new slave are as follows:
(1) The new slave is by default placed in the passive group. In this case, the management of the active group polling ring is not affected, since no elements have to be inserted in the ring for the new slave.
(2) The new slave is by default placed in the active group. In this case, the PS inserts W_{E} elements in the ring for the new slave. Since M is initialized to 1, W_{E}=W_{B} for the new slave, unless it is a VBR slave. If the new slave is a VBR slave from the start (i.e., if the new slave has QoS requirements that do not have to be negotiated through a message exchange, its initial W_{E}=W_{B}+K₁, where K₁ theoretically may take any value in the range [Kₘᵢₙ, Kₘₐₓ]).

When the intra-piconet scheduler is informed by another entity (e.g., an entity in the link manager) that a slave has been disconnected from the piconet, the PS removes this slave from its slave records. If the disconnected slave was in the active group, all the elements of that slave are removed from the ring.

FIG. 11 is a flow chart illustrating active group polling ring management. The events described above, which are referred to as triggering events, are: 1) a slave is moved into the active group; 2) a slave is moved out of the active group; 3) a PMP slave leaves the piconet; 4) a PMP slave returns to the piconet; 5) the K parameter is changed for a VBR slave; 5) W_{B} is changed for a slave; 6) the M parameter is changed for a PMP slave; 7) a new slave is connected to the piconet; and 8) a slave is disconnected from the piconet.

The following assumptions apply to the flow chart in FIG. 11: 1) when a PMP slave leaves the piconet, all its elements are removed from the ring; and 2) when elements are inserted in the ring, the insertions are not distributed in time. The generic expression W_{E}=M×W_{B}+K is used. This expression is valid, because of the restriction that no slave can simultaneously be a PMP slave and a VBR slave and because the default values are M=1 and K=0 for non-PMP slaves and non-VBR slaves, respectively.

In a flow 1100, execution begins at step 1102. From step 1102, execution proceeds to step 1104. At step 1104, a determination is made whether a triggering event has occurred. If it not so determined at step 1104, execution returns to step 1104. If, at step 1104, it is determined that a triggering event has occurred, execution proceeds to step 1106, at which step a determination is made whether a slave has entered the active group. In response to a determination at step 1106 that a slave has entered the active group, execution proceeds to step 1108, as which step the slave is marked active. From step 1108, execution proceeds to step 1110, at which step a determination is made whether the slave is present.

If it is so determined at step 1110, execution proceeds to step 1112. At step 1112, W_{E} elements are inserted in the ring. If, at step 1110, it is not determined that the slave is present, execution returns to Z (i.e., step 1104). If, at step 1106, it is determined that the slave has not entered the active group, execution proceeds to step 1114. At step 1114, a determination is made whether the slave has left the active group. If it is so determined at step 1114, execution proceeds to step 1116, at which step the slave is marked passive. From step 1116, execution proceeds to step 1118, at which step a determination is made whether the slave is present. If it is so determined, execution proceeds to step 1120, at which step the slave's element(s) are removed from the ring. From step 1120, execution proceeds to Z. If, at step 1118, it is not determined that the slave is present, execution proceeds to Z.

If, at step 1114, it is not determined that the slave has left the active group, execution proceeds to step 1122. At step 1122, a determination is made whether a new W_{B} has been received for a slave. If it is so determined at step 1122, execution proceeds to step 1124, at which step a determination is made whether the new W_{B} is not equal to the old W_{B}. If it is so determined at step 1124, execution proceeds to step 1126, at which step W_{E} is calculated. If it is not so determined at step 1124, execution returns to Z.

From step 1126, execution proceeds to step 1128. At step 1128, a determination is made whether the slave is present. If it is not so determined at step 1128, execution proceeds to Z. If it is so determined at step 1128, execution proceeds to step 1130, at which step a determination is made whether the slave is active. If it not so determined at step 1130, execution proceeds to Z. If it is so determined at step 1130, execution proceeds to either X or Y.

From X, execution proceeds to step 1166, at which step the slave's element(s) are removed from the ring. From step 1166, execution proceeds to step 1168, at which step W_{E} elements are inserted into the ring. From step 1168, execution proceeds to Z.

From Y, execution proceeds to step 1160. At step 1160, a determination is made whether the new W_{E} is greater than the old W_{E}. If it is so determined, execution proceeds to step 1162, at which step additional element(s) are inserted into the ring. If it is not so determined at step 1160, execution proceeds to step 1164, at which step superfluous element(s) are removed from the ring. From each of steps 1162 and 1164, execution proceeds to Z.

Returning now to step 1122, if it is not determined at step 1122 that a new W_{B} has been received for a slave, execution proceeds to step 1132. At step 1132, a determination is made whether a new K has been received for the slave. If it is so determined at step 1132, execution proceeds to step 1134, at which step a determination is made whether K_{new} is not equal to K_{old}. If it is so determined at step 1134, execution proceeds to step 1158, at which step W_{E} is calculated. If, at step 1134, it is not so determined, execution returns to Z.

From step 1132, if it is not determined that a new K has been received for the slave, execution proceeds to step 1136. At step 1136, a determination is made whether the slave has left the piconet. If it is so determined, execution proceeds to step 1138, at which step the slave is marked absent. From step 1138, execution proceeds to step 1140, at which step a determination is made whether the slave is active. If it is not so determined at step 1140, execution returns to Z. If it is so determined at step 1140, execution proceeds to step 1142, at which step the slave's element(s) are removed from the ring. From step 1142, execution proceeds to Z.

Returning to step 1136, if it is not determined at step 1136 that the slave has left the piconet, execution proceeds to step 1144, at which step a determination is made whether the slave has returned to the piconet. If it so determined at step 1144, execution proceeds to step 1146, at which step the slave is marked present. From step 1146, execution proceeds to step 1148, at which step a determination is made whether the slave is active. If it so determined at step 1148, execution proceeds to step 1150. At step 1150, it is determined whether M from SM is not equal to the old M. If it is so determined at step 1150, execution proceeds to step 1154, at which step, W_{E} is calculated. From step 1154, execution proceeds to step 1152, at which step W_{E} elements are inserted into the ring. If it is not so determined at step 1150, execution proceeds to step 1152, at which step, W_{E} elements are inserted into the ring. From step 1152, execution proceeds to Z. If it is not so determined at step 1148, execution proceeds to Z.

Returning to step 1144, if it is not determined that the slave has returned to the piconet, execution proceeds to step 1145A, at which step a determination is made whether a new M has been received for a slave. If it is so determined at step 1145A, execution proceeds to step 1145B, at which step W_{E} is calculated. From step 1145B, execution proceeds to step 1130, at which step execution proceeds as previously described.

Returning to step 1145A, if it is not determined that the slave has returned to the piconet, execution proceeds to step 1156, at which step the determination is made whether a new slave is connected. If it is not so determined, execution proceeds to W. If it is determined at step 1156 that the new slave is connected, execution proceeds to V. From step 1158, execution proceeds to #1 (i.e., step 1130). From V, execution proceeds to step 1170. At step 1170, the slave is included in the slave records. At step 1172, W_{E} is set equal to W_{B}. At step 1174, the slave is marked present and, at step 1176, the slave is marked passive. From step 1176, execution proceeds to Z.

From W, execution proceeds to step 1178, at which step, a determination is made whether the slave was in the active group. If it is so determined at step 1178, execution proceeds to step 1180. At step 1180, the slave's element(s) are removed from the ring. At step 1182, the slave is removed from the slave records and execution proceeds to Z. If, at step 1178, it is not determined that the slave was in the active group, execution proceeds to step 1182.

The previous Detailed Description is of embodiment(s) of the invention. The scope of the invention should not necessarily be limited by this Description. The scope of the invention is instead defined by the following claims and the equivalents thereof.

1. A method of controlling polling of slaves in a piconet, the method comprising:
polling the slaves in accordance with a weighted round robin (WRR) scheme; and
dynamically changing a weight of a participant-in-multiple-piconets (PMP) slave in order to compensate the PMP slave for absence of the PMP slave from the piconet.

2. The method of claim 1, wherein the step of polling comprises:
polling a passive group of slaves responsive to a determination that an active group of slaves is empty; and
wherein the polling of the passive group of slaves is performed in accordance with one of the following:
a round robin (RR) scheme;
a WRR scheme based, at least in part, on Tₚₒₗₗ values; and
impending expiration of a Tₚₒₗₗ timer.

3. The method of claim 1, further comprising, responsive to impending expiration of a Tₚₒₗₗ timer of a given slave, polling the given slave, regardless of whether the given slave is in an active group or a passive group of the piconet.

4. The method of claim 1, wherein the step of dynamically changing comprises:
tracking presence and absence periods of the PMP slave; and
calculating polling frequency compensation that the PMP slave should receive.

5. The method of claim 4, wherein the step of calculating polling frequency compensation comprises:
calculating an underservice measure relative to the PMP slave;
calculating a weight multiplication factor using the underservice measure; and
calculating an effective weight of the PMP slave using the weight multiplication factor.

6. The method of claim 5, wherein the step of polling comprises polling the PMP slave in accordance with the effective weight.

7. The method of claim 1, wherein the PMP slave is moved from an active group to a passive group of the piconet responsive to there being no data to transmit to or from the PMP slave.

8. An intra-piconet scheduler comprising:
means for executing polling of at least one participant-in-multiple-piconets (PMP) slave;
means for tracking presence and absence periods of the at least one PMP slave; and
means for dynamically changing a weight of the at least one PMP slave to compensate the at least one PMP slave for absence from the piconet.

9. The intra-piconet scheduler of claim 8, wherein the means for executing polling comprises:
means for polling a passive group of slaves responsive to a determination that an active group of slaves is empty; and
wherein the polling of the passive group of slaves is performed in accordance with one of the following:
a round robin (RR) scheme;
a WRR scheme based, at least in part, on Tₚₒₗₗ values; and
impending expiration of a Tₚₒₗₗ timer.

10. The intra-piconet scheduler of claim 8, wherein the means for executing polling comprises means for polling the given slave responsive to impending expiration of a Tₚₒₗₗ timer of a given slave, regardless of whether the given slave is in an active group or a passive group of the piconet.

11. The intra-piconet scheduler of claim 8, wherein the means for tracking comprises means for calculating polling frequency compensation that the PMP slave should receive.

12. The intra-piconet scheduler of claim 11, wherein the calculation of the polling frequency compensation comprises:
calculating an underservice measure relative to the PMP slave;
calculating a weight multiplication factor using the underservice measure; and
calculating an effective weight of the PMP slave using the weight multiplication factor.

13. The intra-piconet scheduler of claim 12, wherein the means for executing polling comprises means for polling the PMP slave in accordance with the effective weight.

14. The intra-piconet scheduler of claim 8, wherein the PMP slave is moved from an active group to a passive group of the piconet responsive to there being no data to transmit to or from the PMP slave.

15. A method of controlling polling of slaves in a piconet, the method comprising:
polling the slaves in accordance with a weighted round robin (WRR) scheme;
dynamically changing an effective weight of a variable-bit-rate (VBR) slave in order to maintain at least one of an agreed bit rate and a polling rate of the VBR slave.

16. The method of claim 15, wherein the step of dynamically changing comprises:
maintaining a poll counter relative to the VBR slave;
calculating a weight increase parameter using a value of the poll counter; and
adding the weight increase parameter to a basic weight of the VBR slave to yield an effective weight.

17. The method of claim 15, wherein the step of polling comprises using the effective weight.

18. The method of claim 16, wherein the weight increase parameter is a function of the poll counter value.

19. The method of claim 17, wherein the step of polling using the effective weight compensates the VBR slave for time spent by the VBR slave in a passive group of the piconet.

20. The method of claim 19, wherein the VBR slave is moved from an active group to the passive group responsive to there being no data to transmit to or from the VBR slave.

21. The method of claim 20, wherein a VBR slave in the passive group has an effective weight equal to zero and is polled only when Tₚₒₗₗ expiration is imminent or the active group is empty.

22. An intra-piconet scheduler comprising:
means for executing polling of slaves of the piconet;
means for tracking a polling frequency of at least one variable-bit-rate (VBR) slave; and
means for dynamically changing a weight of the at least one VBR slave to maintain at least one of an agreed mean bit rate and a polling rate.

23. The intra-piconet scheduler of claim 22, wherein the means for tracking comprises:
means for maintaining a poll counter relative to the VBR slave;
means for calculating a weight increase parameter using a value of the poll counter; and
means for adding the weight increase parameter to a basic weight of the VBR slave to yield an effective weight.

24. The intra-piconet scheduler of claim 22, wherein the intra-piconet scheduler is adapted to poll the slaves using the effective weight.

25. The intra-piconet scheduler of claim 23, wherein the weight increase parameter is a function of the poll counter value.

26. The intra-piconet scheduler of claim 23, wherein the means for executing polling comprises means for using the effective weight to compensate the VBR slave for time spent by the VBR slave in a passive group of the piconet.

27. The intra-piconet scheduler of claim 26, wherein the VBR slave is moved from an active group to the passive group responsive to there being no data to transmit to or from the VBR slave.

28. The intra-piconet scheduler of claim 27, wherein a VBR slave in the passive group has an effective weight equal to zero and is polled only when Tₚₒₗₗ expiration is imminent or the active group is empty.

29. A method of controlling polling of slaves in a piconet, the method comprising:
polling the slaves in accordance with a weighted round robin (WRR) scheme;
dynamically changing the effective weight of a PMP slave to compensate the PMP slave for absence from the piconet; and
dynamically changing the effective weight of a variable-bit-rate (VBR) slave to maintain at least one of an agreed mean bit rate and a polling rate of the VBR slave.

30. The method of claim 29, wherein:
the step of dynamically changing the effective weight of the PMP slave comprises:
tracking presence and absence periods of the PMP slave; and
calculating polling frequency compensation that the PMP slave should receive; and
the step of dynamically changing the effective weight of the VBR slave comprises:
maintaining a poll counter relative to the VBR slave;
calculating a weight increase parameter using a value of the poll counter; and
adding the weight increase parameter to a basic weight of the VBR slave to yield an effective weight.

31. The method of claim 30, wherein the step of calculating polling frequency compensation comprises:
calculating an underservice measure relative to the PMP slave;
calculating a weight multiplication factor using the underservice measure; and
calculating an effective weight of the PMP slave using the weight multiplication factor.

32. The method of claim 29, wherein:
the PMP slave is moved from an active group to a passive group of the piconet responsive to there being no data to transmit to or from the PMP slave; and
the VBR slave is moved from an active group to a passive group of the piconet responsive to there being no data to transmit to or from the VBR slave.

33. An intra-piconet scheduler comprising:
means for executing polling of slaves of a piconet; and
means for tracking, inter-operably connected to the means for executing polling, the means for tracking comprising:
means for tracking a polling frequency of at least one variable-bit-rate (VBR) slave and dynamically changing a weight of the at least one VBR slave to maintain at least one of an agreed mean bit rate and a polling rate of the VBR slave; and
means for tracking presence and absence periods of at least one PMP slave and dynamically changing a weight of the at least one PMP slave to compensate the at least one PMP slave for absence from the piconet.

34. The intra-piconet scheduler of claim 33, wherein the means for tracking comprises:
means for calculating polling frequency compensation that the PMP slave should receive;
means for maintaining a poll counter relative to the VBR slave;
means for calculating a weight increase parameter for the VBR slave using a value of the poll counter; and
means for adding the weight increase parameter for the VBR slave to a basic weight of the VBR slave to yield an effective weight of the VBR slave.

35. The intra-piconet scheduler of claim 34, wherein the means for tracking comprises:
means for calculating an underservice measure relative to the PMP slave;
means for calculating a weight multiplication factor using the underservice measure; and
means for calculating an effective weight of the PMP slave using the weight multiplication factor.

36. The intra-piconet scheduler of claim 33, wherein:
the PMP slave is moved from an active group to a passive group of the piconet responsive to there being no data to transmit to or from the PMP slave; and
the VBR slave is moved from an active group to a passive group of the piconet responsive to there being no data to transmit to or from the VBR slave.

37. A method of slave polling in a piconet, the method comprising:
representing slaves in an active group as elements in a ring;
assigning, to each slave in the active group, of at least one element;
wherein the at least one element of each slave is proportional to an effective weight of the slave;
maintaining a pointer for tracking a current polling position in the ring;
performing slave polling by sequentially progressing around the ring at least one time.

38. The method of claim 37, the method comprising:
inserting at least one element into the ring responsive to at least one of:
a slave present in the piconet entering the active group;
a slave absent from the piconet entering the active group;
a participant-in-multiple-piconets (PMP) slave entering the piconet; and
an effective weight of a slave increasing; and
deleting an element from the ring responsive to at least one of:
a slave leaving the active group;
an effective weight of a slave decreasing; and
a participant-in-multiple-piconets (PMP) slave leaving the piconet.

39. The method of claim 37, the method comprising:
inserting at least one element into the ring in response to a slave present in the piconet entering the active group; and
wherein the at least one inserted element is proportional to an effective weight of the slave entering the active group.

40. The method of claim 39, wherein the step of inserting comprises:
distributing the at least one inserted element with L//W_{E} elements between successive elements of the at least one inserted element;
wherein L is the total number of elements in the ring prior to insertion of the at least one element; and
wherein W_{E} is the number of elements of the at least one inserted element.

41. The method of claim 39, wherein the step of inserting comprises:
distributing the at least one inserted element with (2L+W_{E})//(2W_{E}) elements between successive elements of the at least one inserted element;
wherein L is the total number of elements in the ring prior to insertion of the at least one element; and
wherein W_{E} is the number of elements of the at least one inserted element.

42. The method of claim 39, wherein the step of inserting comprises:
distributing the at least one inserted element with W_{E}//L elements between successive elements of the at least one inserted element responsive to a determination that W_{E}>L;
wherein L is the total number of elements in the ring prior to insertion of the at least one element; and
wherein W_{E} is the number of elements of the at least one inserted element.

43. The method of claim 39, wherein the step of inserting comprises:
distributing the at least one inserted element with (L//W_{E})+1 elements between successive elements of the at least one inserted element;
wherein L is the total number of elements in the ring prior to insertion of the at least one element; and
wherein W_{E} is the number of elements of the at least one inserted element.

44. The method of claim 39, wherein the step of inserting comprises:
distributing an element of the at least one inserted element with L//W_{E} intermediate elements between successive elements of the at least one inserted element responsive to a determination that DefSur≧10;
distributing an element of the at least one inserted element with L//W_{E}+1 intermediate elements between successive elements of the at least one inserted element responsive to a determination that DefSur>10;
wherein DefSur=DefSur+D following insertion of the element with L//W_{E} intermediate elements;
wherein DefSur=DefSur−(10−D) following insertion of the element with L//W_{E}+1 intermediate elements;
wherein D=10L//W_{E}−10(L//W_{E});
wherein L is the total number of elements in the ring prior to insertion of any element of the at least one element; and
wherein W_{E} is the number of elements of the at least one inserted element.

45. A method of adjusting an underservice measure of a participant-in-multiple-piconets (PMP) slave in a piconet, the method comprising:
increasing the underservice measure responsive to the PMP slave being in an active group of the piconet and absent from the piconet;
decreasing the underservice measure responsive to the PMP slave being in the active group of the piconet and present in the piconet; and
setting the underservice measure to zero responsive to the PMP slave being in a passive group of the piconet.

46. A method of slave polling in a piconet, the method comprising:
determining whether an active group of the piconet is not empty;
responsive to a determination that the active group is not empty, polling members of the active group in accordance with a weighted round robin (WRR) scheme;
responsive to a determination that the active group is empty, polling members of a passive group of the piconet.

47. The method of claim 46, the method comprising:
expiring of a Tₚₒₗₗ timer of a slave;
responsive to the expiring step, polling the slave; and
wherein the polling of the slave occurs regardless of whether the slave is in the active group.

48. A method of compensating a participant-in-multiple-piconets (PMP) slave for absence from a piconet, the method comprising:
calculating an underservice measure relative to the PMP slave;
calculating a weight multiplication factor using the underservice measure;
calculating an effective weight of the PMP slave using the weight multiplication factor; and
polling the PMP slave in accordance with the effective weight.

49. A method of compensating a variable-bit-rate (VBR) slave for lost capacity, the method comprising:
maintaining a poll counter relative to the VBR slave;
calculating a weight increase parameter using a value of the poll counter;
adding the weight increase parameter to a basic weight of the VBR slave to yield an effective weight; and
polling the VBR slave in accordance with the effective weight.

50. An intra-piconet scheduler comprising:
a polling scheduler for executing polling of at least one participant-in-multiple-piconets (PMP) slave;
a slave manager, inter-operably connected to the polling scheduler, for tracking presence and absence periods of the at least one PMP slave and dynamically changing a weight of the at least one PMP slave to compensate the at least one PMP slave for absence from the piconet.

51. The intra-piconet scheduler of claim 50, wherein the polling scheduler is adapted to:
poll a passive group of slaves responsive to a determination that an active group of slaves is empty; and
wherein the polling of the passive group of slaves is performed in accordance with one of the following:
round robin (RR) scheme;
a WRR scheme based, at least in part, on Tpoll values; and
impending expiration of a Tpoll timer.

52. The intra-piconet scheduler of claim 50, wherein the polling scheduler is further adapted to poll the given slave responsive to impending expiration of a Tpoll timer of a given slave, regardless of whether the given slave is in an active group or a passive group of the piconet.

53. The intra-piconet scheduler of claim 50, wherein the slave manager is further adapted to:
track presence and absence periods of the PMP slave; and
calculate polling frequency compensation that the PMP slave should receive.

54. The intra-piconet scheduler of claim 53, wherein the calculation of the polling frequency compensation comprises:
calculating an underservice measure relative to the PMP slave;
calculating a weight multiplication factor using the underservice measure; and
calculating an effective weight of the PMP slave using the weight multiplication factor.

55. The intra-piconet scheduler of claim 54, wherein the polling scheduler is further adapted to poll the PMP slave in accordance with the effective weight.

56. The intra-piconet scheduler of claim 50, wherein the PMP slave is moved from an active group to a passive group of the piconet responsive to there being no data to transmit to or from the PMP slave.

57. An intra-piconet scheduler comprising:
a polling scheduler for executing polling of slaves of the piconet;
a slave manager, inter-operably connected to the polling scheduler, for tracking a polling frequency of at least one variable-bit-rate (VBR) slave and dynamically changing a weight of the at least one VBR slave to maintain at least one of an agreed mean bit rate and a polling rate.

58. The intra-piconet scheduler of claim 57, wherein the slave manager is adapted to:
maintain a poll counter relative to the VBR slave;
calculate a weight increase parameter using a value of the poll counter; and
add the weight increase parameter to a basic weight of the VBR slave to yield an effective weight.

59. The intra-piconet scheduler of claim 57, wherein the polling scheduler is adapted to poll the slaves using the effective weight.

60. The intra-piconet scheduler of claim 58, wherein the weight increase parameter is a function of the poll counter value.

61. The intra-piconet scheduler of claim 58, wherein the polling scheduler is adapted to use the effective weight to compensate the VBR slave for time spent by the VBR slave in a passive group of the piconet.

62. The intra-piconet scheduler of claim 61, wherein the VBR slave is moved from an active group to the passive group responsive to there being no data to transmit to or from the VBR slave.

63. The intra-piconet scheduler of claim 62, wherein a VBR slave in the passive group has an effective weight equal to zero and is polled only when Tpoll expiration is imminent or the active group is empty.

64. An intra-piconet scheduler comprising:
a polling scheduler for executing polling of slaves of a piconet; and
a slave manager, inter-operably connected to the polling scheduler, for:
tracking a polling frequency of at least one variable-bit-rate (VBR) slave and dynamically changing a weight of the at least one VBR slave to maintain at least one of an agreed mean bit rate and a polling rate of the VBR slave; and
tracking presence and absence periods of at least one PMP slave and dynamically changing a weight of the at least one PMP slave to compensate the at least one PMP slave for absence from the piconet.

65. The intra-piconet scheduler of claim 64, wherein the slave manager is adapted to:
track presence and absence periods of the PMP slave;
calculate polling frequency compensation that the PMP slave should receive;
maintain a poll counter relative to the VBR slave;
calculate a weight increase parameter for the VBR slave using a value of the poll counter; and
add the weight increase parameter for the VBR slave to a basic weight of the VBR slave to yield an effective weight of the VBR slave.

66. The intra-piconet scheduler of claim 65, wherein the slave manager is adapted to:
calculate an underservice measure relative to the PMP slave;
calculate a weight multiplication factor using the underservice measure; and
calculate an effective weight of the PMP slave using the weight multiplication factor.

67. The intra-piconet scheduler of claim 64, wherein:
the PMP slave is moved from an active group to a passive group of the piconet responsive to there being no data to transmit to or from the PMP slave; and
the VBR slave is moved from an active group to a passive group of the piconet responsive to there being no data to transmit to or from the VBR slave.
